(19) United States
(12) Patent Application Publication
(10) Pub. No.: US 2003/0014513 A1
(43) Pub. Date: Jan. 16, 2003

(54) System and method for collaborative data resource representation

(76) Inventors: Derek Augustus Samuel Ruths, Sugar Land, TX (US); Jefferson David Hoye, Houston, TX (US)

Correspondence Address: Robert C. Kowert, Conley, Rose, & Tayon, P.C., P.O. Box 398, Austin, TX, 78767, US

(21) Appl. No.: 10/242,555

(22) Filed: Sep. 12, 2002

Related U.S. Application Data
(63) Continuation-in-part of application No. 09/749,203, filed on Dec. 27, 2000.
(60) Provisional application No. 60/322,931, filed on Sep. 18, 2001.

(51) Int. Cl. G06F 15/173

(52) U.S. Cl. 709/223

(57) ABSTRACT

In a collaborative environment a collaborative platform for each participant may include a collaborative data resource representation for each collaborative data resource used in that collaborative environment. For each collaborative data resource, one of the participants' collaborative platform may be the host or server for that collaborative data resource. The collaborative data resource representation managed by the host collaborative platform is referred to as the server data representation. Every other participants' collaborative platform may manage a client data representation of that collaborative data resource. When an application makes a change to a collaborative data resource, the change is made for the server data representation and then the collaborative platform managing the server data representation sends state information to each client data representation of that collaborative data resource to reflect the change made to the server data representation.

### PRIORITY INFORMATION

This application is a continuation-in-part of U.S. patent application Ser. No. 09/749,203 titled “Method of Manipulating a Distributed System of Computer-Implemented Objects” filed on Dec. 27, 2000.

This application also claims benefit of priority to U.S. Provisional Application No. 60/322,931 filed on Sep. 18, 2001.

### BACKGROUND

1. Field of the Disclosure

This invention relates to distributed and collaborative computing, and to manipulating and communicating between computer-implemented objects.

2. Description of the Related Art

The Internet has allowed fundamental change in how people work, learn and are entertained, but the experience is largely asynchronous—users see what others have done, but typically cannot share information with each other in real-time. Limited collaboration capability has been provided by specialized products such as Microsoft Netmeeting™, Webex™ and AOL Instant Messenger™ for specific applications such as collaborative chat, and Napster™ for asynchronous peer-to-peer music file sharing. Peer-to-peer (P2P) computing is especially attractive for real-time collaborative computing. However, current P2P computing technologies typically require specialized applications and do not integrate with existing single-user applications.

Other conventional collaborative products require specialized hardware and/or dedicated connections. Also, some conventional collaborative systems allow only one active participant, with the other participants capable only of passive viewing. For example, a collaborative graphics application may allow one user to make changes to an image and then transmit the image to each other collaborative user as changes are made. Most conventional collaborative software uses technology that projects an image from a host application across a network. Such systems may be extremely bandwidth intensive, especially for real-time applications.

Technologies such as the Object Management Group's Common Object Request Broker Architecture (CORBA) and Microsoft's Component Object Model (COM) allow objects to be accessed by different applications, as long as the applications are CORBA or COM compliant. However, these architectures do not provide support for managing a collaborative environment.

Collaborative computing has the potential to be applied to many various applications and industries. For example, collaborative computing may be advantageously employed in distance learning (e.g. Internet classrooms), on-line gaming, medical imaging collaboration (e.g. radiologists at remote locations may collaborate in real-time over x-ray images), enterprise applications, business-to-business applications (e.g. supply chain management), Internet publishing, etc. However, conventional collaborative solutions are typically specialized for a single specific application and are not flexible enough to support development of various different collaborative applications.

### SUMMARY OF THE INVENTION

A collaborated platform on each participant may manage distributed representations of a data resource. The collaborative platforms may synchronize changes to the resource between participants. The collaborative platforms may abstract this distributed collaborative data management from participant applications. From the perspective of the participant applications, it may appear as if each participant is accessing one central collaborative resource since the collaborative platform abstracts the distributed resource management from the participant applications. In one embodiment, each collaborative resource may have a server representation locally managed by the collaborative platform on one participant (the host participant for that collaborative resource). Each collaborative resource may be “shadowed” on other (non-host) participants such that a client representation is locally managed by the collaborative platform on each of the other participants participating in the collaboration.

In a collaborative environment a collaborative platform for each participant may include a collaborative data resource representation for each collaborative data resource used in that collaborative environment. For each collaborative data resource, one of the participants' collaborative platform may be the host or server for that collaborative data resource. The collaborative data resource representation managed by the host collaborative platform is referred to as the server data representation. Every other participants' collaborative platform may manage a client data representation of that collaborative data resource. When an application makes a change to a collaborative data resource, the change is made for the server data representation and then the collaborative platform managing the server data representation sends state information to each client data representation of that collaborative data resource to reflect the change made to the server data representation.

In one embodiment, a system may include a network and a plurality of participant devices coupled to the network for collaborating on a plurality of collaborative resources. Each of the participant devices may include a local data representation of each collaborative resource. For each collaborative resource, the local data representation at one of the participant devices is a server representation of the collaborative resource and the local data representations at the other participant devices are client representations of the collaborative resource. For each collaborative resource, the participant device having the server representation is configured to coordinate state changes to the collaborative resource among the local data representations of the participant devices. For each collaborative resource, the participant devices having the client representations are configured to receive state changes for the collaborative resource from the participant device having the server representation.

In one embodiment, a device may include a network interface configured to couple the device to a network for communicating with one or more other devices. The device may also include a server representation of a first collaborative resource. The server representation may be configured to receive notification of state changes to the collaborative resource and send state change instructions through the network interface to the other devices to coordinate the state changes to client representations of the first collaborative resource at the other devices. The device may include a client representation of a second collaborative resource. The client representation may be configured to receive state change instructions for the second collaborative resource through the network interface from one of the other devices having a server representation of the collaborative resource. The client representation may be configured to update its state in response to the state change instructions for the second collaborative resource.

In one embodiment, a distributed computing method may include distributing a local data representation of a first collaborative resource to each of a plurality of participant devices. The local data representation at one of the participant devices is a server representation and the local data representations at the other participant devices are client representations. The method may further include the server representation receiving a state change for the first collaborative resource, updating its state and relaying the state change to the client representations. The method may also include the client representations each updating their state in response to receiving the state change from the server representation.

### BRIEF DESCRIPTION OF THE DRAWINGS

The following detailed description makes reference to the accompanying drawings, which are now briefly described.

FIG. 1 is an abstract illustration of the sharing of various computer-implemented objects by multiple participants in a collaborative environment, according to one embodiment.

FIG. 2 illustrates a collaborative system including various participant devices coupled to one or more networks, according to one embodiment.

FIG. 3 illustrates a participant device that includes a collaborative platform, according to one embodiment.

FIG. 4 illustrates components of a collaborative platform, according to one embodiment.

FIG. 5 illustrates a block diagram of a collaborative platform network engine and connectivity to other participant devices, according to one embodiment.

FIG. 6 illustrates interaction between an application and collaborative platform through adapter on a participant device, according to one embodiment.

FIG. 7A illustrates a method for interfacing application events to a collaborative environment, according to one embodiment.

FIG. 7B illustrates a method for interfacing collaborative resource events to a participant application, according to one embodiment.

FIGS. 8A and 8B illustrate a plurality of different participant applications coupled to a collaborative environment via respective adapters, according to one embodiment.

FIG. 9 illustrates a method for data-centric collaboration among a plurality of participants, according to one embodiment.

FIG. 10 illustrates multiple participants in a collaborative environment having server and client representations of collaborative resources, according to one embodiment.

FIG. 11 illustrates a collaborative environment created by a collaborative resource abstraction in which each participant has a server or client data representation of the collaborative resources, according to one embodiment.

FIG. 12A illustrates a unified visualization model of structured collaborative data as it may conceptually exist in a collaborative environment, according to one embodiment.

FIG. 12B illustrates structured collaborative data as it may exist physically in a collaborative environment, according to one embodiment.

FIGS. 13A-13D illustrate the establishment of a new collaborative session between a plurality of participants, according to one embodiment.

FIG. 14 illustrates multiple local environments participating in a collaborative environment, according to one embodiment.

FIGS. 15A-15C illustrate a process for synchronizing a modification to a client representation, according to one embodiment.

FIGS. 16A-16B illustrate a process for synchronizing a modification to a server representation, according to one embodiment.

FIGS. 17A-17D illustrate arbitration and resolution of conflicting state changes to a collaborative resource by the server representation, according to one embodiment.

FIGS. 18A-18F illustrate a process for synchronizing a modification that affects multiple representations, according to one embodiment.

FIG. 19 illustrates connection between collaborative data representations that represent the same collaborative resource, according to one embodiment.

FIG. 20 illustrates a session graph of connections between local environments in a collaborative environment, according to one embodiment.

FIG. 21 illustrates a collaborative resource's connection graph superimposed over a session graph for participants in a collaborative environment, according to one embodiment.

FIGS. 22A-22C illustrate an example of a host participant initiating a mutation to transfer server host responsibility for a collaborative resource to another participant, according to one embodiment.

FIGS. 23A-23B illustrate a collaborative resource mutation that may occur when a server representation becomes disconnected from the rest of a session graph, according to one embodiment.

FIG. 24 illustrates collaborative resource mutation used to dynamically switch between peer-to-peer and client-server collaborative computing environments, according to one embodiment.

FIG. 25 illustrate an example in which a traditionally single user application, such as a spreadsheet application, is allowed to participate in a collaborative environment with another spreadsheet application, according to one embodiment.

FIG. 26 illustrates the unified view of a collaborative environment from the perspective of the applications of FIG. 25, according to one embodiment.

FIG. 27 illustrates different types of applications participating in a collaborative environment, according to one embodiment.

FIG. 28 illustrates client applications receiving basic collaborative components or static portions of a collaborative resource from a repository and server in a traditional client-server fashion and collaborative actions and/or data being accessed in a collaborative environment, according to one embodiment.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the option or potential to), rather than the mandatory sense (i.e., meaning must). Similarly, the words “has”, “have”, “having”, “include”, “including”, and “includes” are used in a non-restrictive sense, e.g. to mean having or including, but not limited to. The term “connected” means “directly or indirectly connected,” and the term “coupled” means “directly or indirectly connected.”

### DETAILED DESCRIPTION OF EMBODIMENTS

A system and method for collaborative computing are described in which a collaborative platform may be provided to facilitate the development and deployment of a collaborative environment. New or existing applications may be layered with the collaborative platform on various local environments to create a collaborative environment among multiple participants. A data-centric abstraction may be used to abstract collaborative objects from individual applications. In some embodiments, the collaborative environment may span different participants, applications, networks, devices and platforms to provide real-time collaboration. The collaborative environment may enable multiple entities (e.g. people, objects, automatons, etc.) on participant devices to work cooperatively to complete a task in a more efficient manner than it might be completed if it were performed non-cooperatively. An approach to collaboration is created in which the focus for task performance is around the data or object upon which the task is performed. The data-centric abstraction is provided by the collaborative platforms at each local environment coordinating changes to data or object that is the focus of the collaboration.

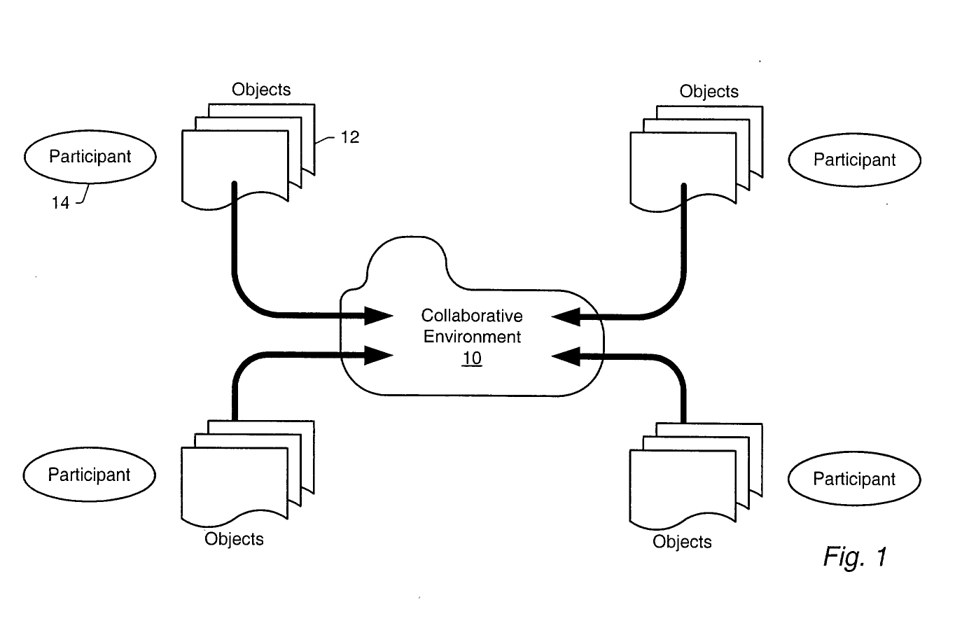

FIG. 1 is an abstract illustration of the sharing of various computer-implemented objects 12 by multiple participants 14 in a collaborative environment 10. In one embodiment, a collaborative platform is provided on each participant in the collaborative environment. The collaborative platform may be a software system which facilitates the development and deployment of collaborative content by providing high-level services which abstract away the low-level detail of networking and distributed environment synchronicity. The collaborative platform (and thus the shared collaborative environment) may be data-centric so that collaboration occurs on a collaborative resource (which represents data and/or metadata). Participant applications, which use the collaborative data, become collaborative via the collaborative platform.

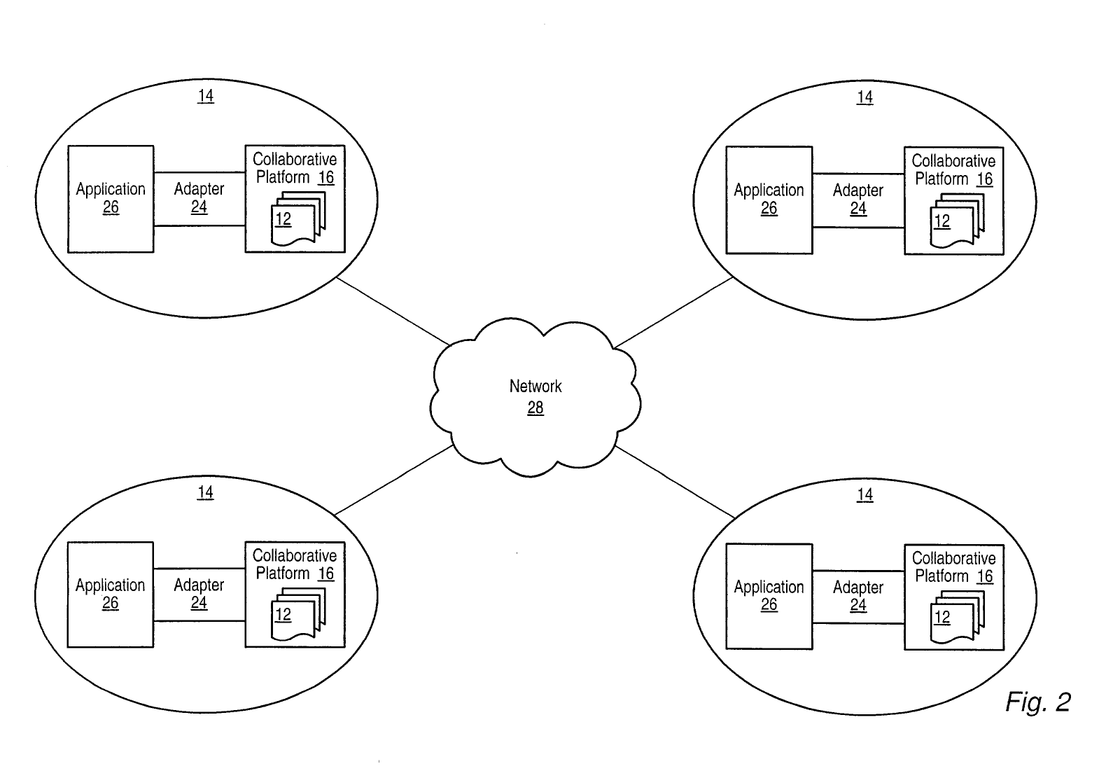

FIG. 2 illustrates a collaborative system including various participant devices 14 coupled to one or more networks 28. Each participant device 14 may include a collaborative platform 16. The term collaborative platform is used herein to refer to the mechanism provided on a participant to allow that participant to participate in the collaborative environment 10. In one embodiment, the collaborative platform 16 may be a single instance of a software system running on a participant device 14. A participant device 14 may be, for example, a desktop computer, server, mainframe, supercomputer, notebook or laptop computer, personal digital assistant (PDA), mobile phone, gaming console, set-top box, etc.

The collaborative platform 16 may be layered with or coupled to one or more applications 26 on participant devices 14 to facilitate development and deployment of a collaborative environment in which all of the participants may take part in a collaborative session. Thus, each participant 14 may include a collaborative platform 16 and an application 26. Applications 26 may provide a “window” to the collaborative objects 12. An application 26 may be the mechanism through which a user views and/or manipulates collaborative objects 12. The collaborative platforms 16 may provide a collaborative resource abstraction from the participant applications 26 so that the participant applications do not need to include any special collaborative functionality of their own. In some embodiments, an adapter 24, or any other suitable mechanism, may provide an interface between the application 26 and collaborative platform 16. Participants 14 may be coupled together through network 28, such as a local area network (LAN), the internet, or other networks and/or combinations of networks. The collaborative platform 16 allows each participant application to collaborate over collaborative data resources represented by collaborative objects 12.

Each collaborative platform 16 manages a local representation 12 of a collaborative resource. The collaborative platforms on each participant device may communicate among each other to synchronize collaborative resource changes to the local data representations. Synchronizing may include replicating changes in the state of a collaborative resource to local environments of the participant devices for the purpose of maintaining a consistent state between the multiple representations of the collaborative resource. The collaborative platforms 16 may maintain a real-time cause and effect relationship between local environments such that a state change initiated in one local environment may be perceived as being related to its cause due to the closeness in temporal locality in which the state change is replicated to the other local environments. A collaborative platform 16 may employ an active event notification mechanism for communicating state changes with a local application 26.

In some embodiments, an application 26 may interact with the collaborative data using an adapter 24 to the collaborative platform 16. An adapter may translate application-level interactions into modifications to the collaborative data and visa versa. In some embodiments, adapters 24 may make use of an externally visible API (application program interface), which the application provides (such as COM or JavaScript methods). Thus, with the addition of an adapter 24 and the collaborative platform 16, existing applications 26 that already have such an API may become collaborative with little or no change to the application. In other embodiments, the functionality of an adapter 24 may be added to an application 26 or an application 26 may be modified to interact with the collaborative platform 16. Modifying an application 26 to interact with the collaborative platform 16 may entail identifying the locations where events occur and adding code to notify the collaborative platform 16 that an event occurred. In many embodiments, such modification to existing applications may be very minor (e.g. addition of a single line of code for an event notification). In other embodiments, any suitable mechanism may be employed to integrate new or existing applications to the collaborative platform.

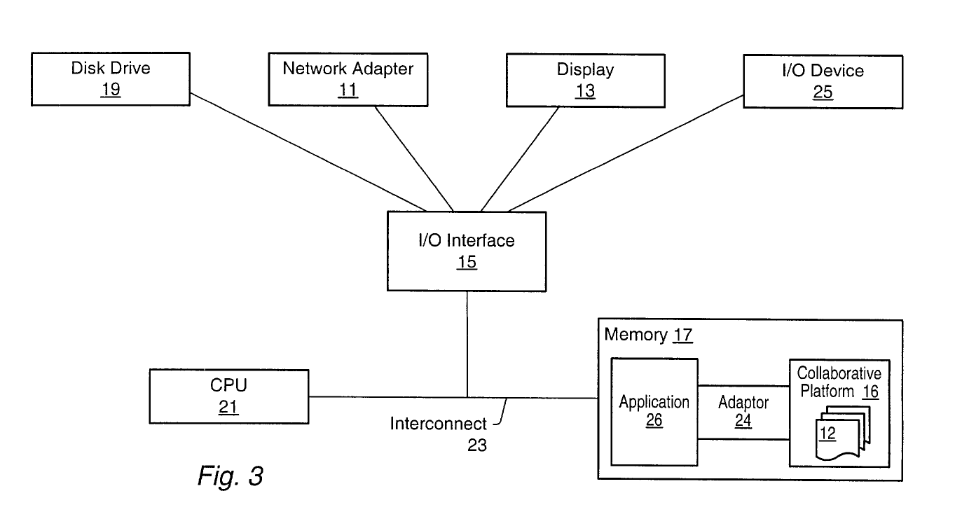

FIG. 3 illustrates one embodiment of a participant device 14 that may include a collaborative platform 16. A participant device may include various components such as memory 17, one or more central processing units (CPU) or processors 21, device interconnect 150, one or more input/output (I/O) interfaces 15, and I/O devices such as one or more disk drives 19, network adapter 11, display 13 and/or other I/O devices 25. Interconnect 150 may provide a communication path from one component to another. For example, interconnect 150 may be a point-to-point interconnect, a shared bus, a combination of point-to-point interconnects and one or more buses, and/or a bus hierarchy including a system bus, CPU bus, memory bus and I/O buses such as a peripheral component interconnect (PCI) bus. Memory 17 may store program instructions accessible and executable by the CPU 21. For example, instructions and data implementing application 26, adapter 24 and/or collaborative platform 16 may be stored in memory 17. An operating system may also be stored in memory 17. Program instructions to implement application 26, adapter 24 and/or collaborative platform 16 may also or additionally be stored in other storage such as disk drive 19.

Through the I/O interface 15, the CPU 21 may also be coupled to one or more other components, e.g. disk drive 19, network adapter 11, display 13, I/O device(s) 25. I/O interface 15 may include one or more interfaces, e.g. provided by a computer system chipset, to one or more I/O technologies such as PCI (peripheral component interconnect), SCSI (small computer system interface), or other serial, parallel or point-to-point interconnects. Network adapter 11 may provide an interface to a network so that the participant device may communicate with other participant devices and thus participate in a collaborative environment. Collaborative platform 16 may interact with remote collaborative resources through network adapter 11. Display 13 may be any type of display device for generating visible images on a monitor, flat screen display, etc. Other I/O devices 25 may include track balls, mice, keyboards, printers, plotters, scanners, and/or other types of I/O devices. Application 26 may provide a window to the collaborative resource so that a user may view collaborative resource on display 13 and/or manipulate collaborative resources through other I/O devices.

The term collaborative platform is used herein to refer to the mechanism provided on a participant device to allow that participant to participate in the collaborative environment. In one embodiment, the collaborative platform 16 may be a single instance of a software system running on a participant device, such as a desktop computer, server, mainframe, supercomputer, notebook or laptop computer, personal digital assistant (PDA), mobile phone, gaming console, set-top box, etc. The term local environment is used herein to refer to the environment managed by the locally running collaborative platform 16. A session is a connection between two collaborative platforms such that they share some subset of their local environments. A collaborative environment 10 (as illustrated in FIG. 1) may be viewed as the abstract collaborative space in which resources and participants may interact with each other. The collaborative environment includes connected local environments, and transcends any one collaborative platform.

As mentioned above, the collaborative platform 16 (and thus the shared collaborative environment) may be data-centric so that collaboration occurs on one or more collaborative data resources at a data or object level (a collaborative data resource may be, e.g., an object and/or metadata). Each collaborative data resource may have a server version and a client version. Thus, a representation 12 of a collaborative data resource may be either a server data representation or a client data representation of the collaborative data resource. In one embodiment, only one representation of any given collaborative data resource exists in a single local environment. The host of a collaborative data resource is the local environment which contains the server version of the collaborative data resource. The term mutation is used herein to refer to a collaborative data resource changing its host, e.g., making a local environment which was not originally the host of the collaborative data resource the new host. Mutation is described in more detail below.

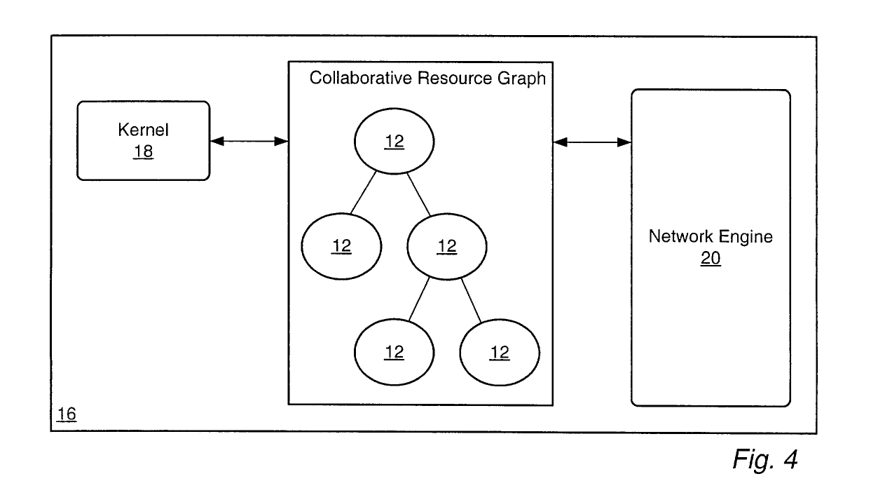

FIG. 4 illustrates components of a collaborative platform 16, according to one embodiment. The collaborative platform 16 may be a software system stored in one or more memory devices and executed on one or more processors of a participant device. In one embodiment, the collaborative platform may be implemented in a device-platform independent language, such as Java. For example, the collaborative platform may run within a Java Virtual Machine (JVM) on the participant device. The collaborative platform may be implemented as a Java plug-in and be downloaded (e.g. from the Internet) to the participant device. Other embodiments may be implemented in other languages, such as C-sharp (C#), and/or natively compiled for a particular device platform.

The collaborative platform 16 may include a kernel 18 which initializes and manages the local environment. The collaborative platform 16 may also include a network engine 20 which provides network services to the local environment. In one embodiment, the network engine 20 may be a collection of objects which provide low level network services to the local environment. The primary services provided or facilitated by the network engine 20 may include:

Formation and destruction of sessions with other collaborative platforms.

Management of the connectivity between collaborative resource data representations, including:

Connectivity of a server data representation in the local environment to client data representation on remote collaborative platforms (in remote local environments).

Connectivity of a client data representation in the local environment back to the server data representation hosted on a remote collaborative platform (in a remote local environment).

One or more local collaborative data resource representations 12 may be managed within collaborative platform 16. Collaborative data resource representations 12 may include both server and client data representations. In one embodiment, collaborative data resources may be organized within a collaborative data resource graph, and the local representations may be organized accordingly. However, the organization of collaborative data resources is not critical.

The collaborative data resource may be viewed as a fundamental unit within a collaborative environment. Collaborative data resource representations 12 interact with the network engine 20 in order to update their corresponding remote representations (e.g. through messages or states, as discussed below).

The kernel 18 bootstraps and manages the collaborative platform. The kernel 18 may manage entry and removal of collaborative data resource representations 12 into the local environment. The kernel may maintain a collaborative data resource registration to which collaborative data resources may be registered and unregistered. The kernel may notify objects in the local environment when a collaborative data resource representation is registered, unregistered or mutated. The kernel may also manage initial configuration of the collaborative platform.

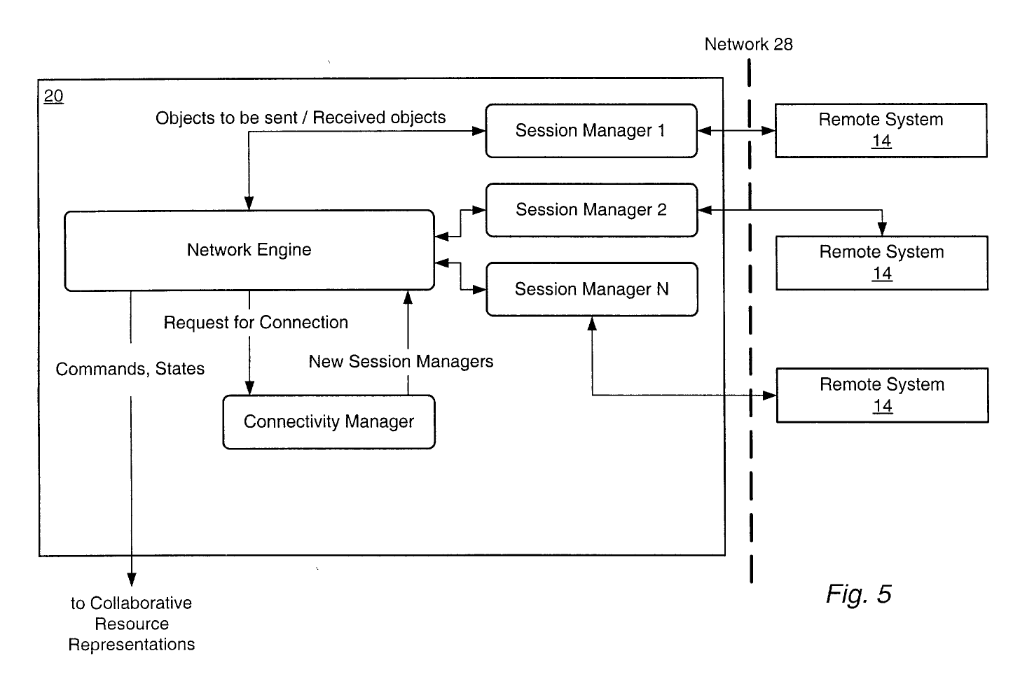

The network engine 20 may provide low level networking services to collaborative data resources in the collaborative environment. FIG. 5 illustrates a block diagram of a network engine and connectivity to other participant devices 14 according to one embodiment. The network engine provides for connection to and disconnection from other collaborative platform network engines on remote participants 14. The network engine provides for sending state information from local server data representations in its local environment to remote client data representations. The network engine also provides for receiving commands or messages from a local client data representation and sending the commands or messages to the remote server data representation for execution. Similarly, the network engine provides for receiving commands or messages from remote participants to be executed on or applied to the server data representations in the local environment and receiving state information from remote participants to update local client data representations. The network engine provides for the network ability of collaborative data resources, instructions (e.g. commands, messages, etc.), and state information to and from the collaborative platform.

A connectivity manager within the network engine may handle the creation and management of a session manager for each collaborative session. Each session manager manages the low level network connections between the local collaborative platform and a remote collaborative platform of a collaborative participant.

The collaborative platform components illustrated and described for FIGS. 4 and 5 are given as example implementations. The collaborative platform functionality described herein may be divided or organized in any suitable manner. Embodiments having different numbers or organizations of functional components are contemplated.

The collaborative platform may be layered with one or more applications on participant devices to facilitate development and deployment of a collaborative environment in which all of the participants may take part in a collaborative session. Each participant 14 may include a collaborative platform 16 and one or more applications 26. An adapter 24, or any other suitable mechanism, may provide an interface between the application 26 and collaborative platform 16 to access local collaborative data representations 12. Participants 14 may be connected together through a network such as a local area network (LAN), the internet, or other networks and/or combinations of networks. The collaborative platform 16 allows each participant application to collaborate over collaborative data resources represented by local objects 12. The collaborative platforms 16 may provide a collaborative resource abstraction for the participant applications 26 so that the participant applications do not need to include any special collaborative functionality of their own.

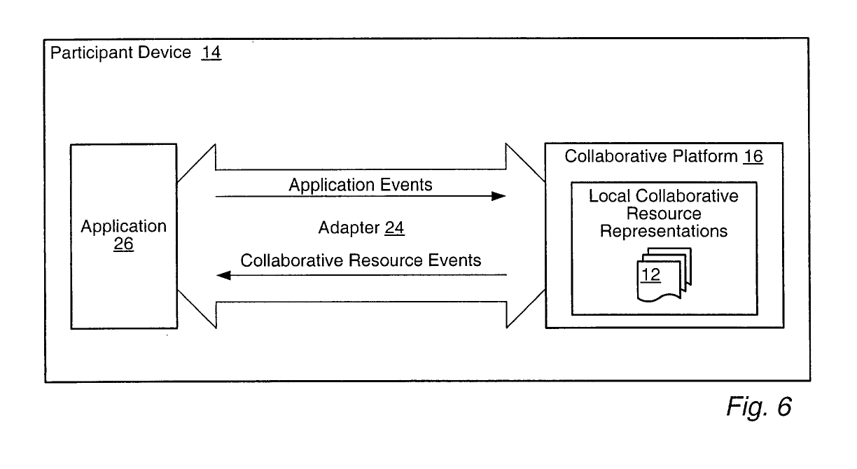

FIG. 6 illustrates interaction between an application 26 and collaborative platform 16 through adapter 24 on a participant device 14. The collaborative platform 16 provides for synchronizing local data representations 12 of collaborative resources with other remote participants. The collaborative platform 16 may provide an abstraction of collaborative resources to application 26 so that to the application 26 it appears that the collaborative resource transcends the participants in that each participant application appears to have direct access to modify and/or observe the collaborative resource. Adapter 24 provides the binding between application 26 and the collaborative platform 16 (and collaborative data representations 12). Adapter 24 may translate changes in the collaborative data representations 12 into changes in the application, and vice versa. The application 26 may be a process and/or user interface through which the collaborative data resource may be observed and/or modified even though the application 26 itself may not be aware of the collaborative nature of the collaborative data resource. Thus, collaborative data resource representations 12 and application 26 may be linked via adapter 24. The adapter may communicate events between collaborative data resource representations 12 and application 26.

From the perspective of a participant in the collaborative environment, it is the application 26 that generates and manifests changes to the collaborative data resource. However, the adapter 24 and platform 16 are the components that communicate events between application 26 and a collaborative resource(s), and ensure that the events are synchronized between participants. Adapter 24 may translate application events into interactions to a collaborative data resource, as indicated by reference numeral 32, and translate collaborative resource events into application events, as indicated by reference numeral 34. The adapter 24 may capture application events through hooks into an event model for the application 26. These hooks may be implemented through method calls, through a standard API (e.g. COM) or through any other mechanism for obtaining notification of events occurring within the application itself. The adapter may translate application events into data interactions to reflect the application event in the collaborative data resource. Through collaborative platform 16 the data interaction is synchronized with other participants and performed on the local representation 12 of the collaborative resource.

Collaborative data resource events (e.g. initiated from other participants) may be received by platform 16 and translated by adapter 24 into application events. Adapter 24 may have hooks into a collaborative data event model of collaborative platform 16 so that adapter 24 receives notification of such events. The adapter may be configured specifically for the particular application 26 so that upon receiving notification of a collaborative data resource event, adapter 24 generates the correct application event to reflect the collaborative data resource event in application 26. Thus, upon translating a collaborative data resource event, adapter 24 may invoke a corresponding event on the application 26. In one embodiment, adapter 24 may employ an inter-process communication mechanism that allows a separate process or object (the adapter) to “instruct” the application to invoke the corresponding event.

An adapter may be configured to translate events for a specific application and/or for a specific type of collaborative data resource. Thus, different adapters may be provided for different applications and/or different collaborative resources. Each adapter is configured to hook into events happening in a corresponding application and generate events in that application. Each adapter may also be configured to hook into events happening in a corresponding collaborative resource(s) and generate interactions with the collaborative resource(s).

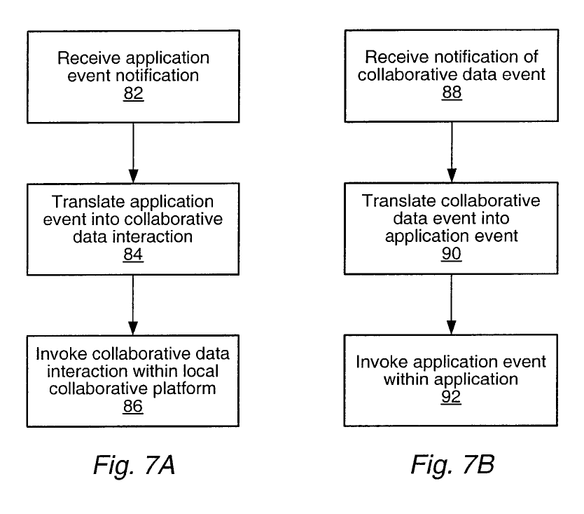

FIG. 7A illustrates a method for interfacing application events to a collaborative environment. A mechanism for binding an application to a collaborative environment may receive notification of the occurrence of an event within the application, as indicated at 82. For example, an application on a participant may make a change to a collaborative data resource. This change event may be received by the binding mechanism (e.g. an adapter). The application event may be translated into a collaborative data interaction as indicated at 84. For example, an adapter that has received the event notification may translate or map the event into a corresponding interaction for the collaborative data resource. The collaborative data interaction may then be invoked within the local collaborative platform, as indicated at 86. For example, an adapter may cause a local representation of the collaborative resource to be modified in response to the application event and the collaborative platform may synchronize the modification with remote representations of the collaborative resource on other participants.

FIG. 7B illustrates a method for interfacing collaborative resource events to a participant application. A mechanism for binding the application to the collaborative environment may receive notification of a collaborative data event, as indicated at 88. For example, a collaborative platform on the participant may receive a communication or command from a remote participant indicating a change to a collaborative data resource. The mechanism for binding the application to the collaborative environment may receive notification of this event and then translate the collaborative data event into one or more application events, as indicated at 90. The binding mechanism (e.g. an adapter) may then invoke the application event or events within the application so that the change made to the collaborative resource will be reflected in the application.

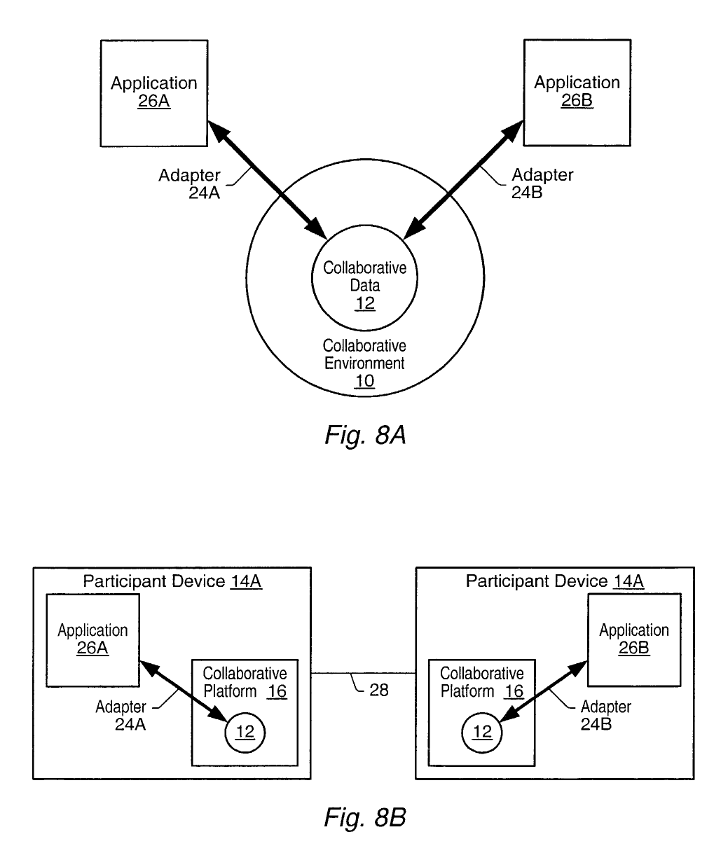

FIG. 8A illustrates a plurality of different participant applications coupled to a collaborative environment via respective adapters. Application 26A and application 26B may collaborate on collaborative data resource 12 via their respective adapters 24A and 24B. For example, application 26A and adapter 24A may be located on one participant device and application 26B and adapter 24B may be located on another participant device. Although only two applications are illustrated in FIG. 8A, any number of participants may be coupled to the collaborative environment. FIG. 8A shows an abstract “unified” illustration of the collaborative environment from the perspective of the participant applications to illustrate that the adapter and collaborative platform on each participant create the illusion of a central single collaborative data resource to the applications. To create this illusion or abstraction to the collaborative environment, a local representation of the collaborative data resource may be managed by the collaborative platform on each participant device, as illustrated in FIG. 8B. Thus, while the adapters and collaborative platforms provide an abstraction to the collaborative data resource 12 so that it appears as a single shared resource as illustrated in FIG. 8A, the actual collaboration may be performed across the various participants so that the underlying collaborative data resource configuration is distributed. A local representation of the collaborative data resource 12 may be managed by the collaborative platform 16 on each participant device 14, as illustrated in FIG. 8B. The collaborative platforms 16 may synchronize collaborative data resource events between participant devices over a network or other communication mechanism 28.

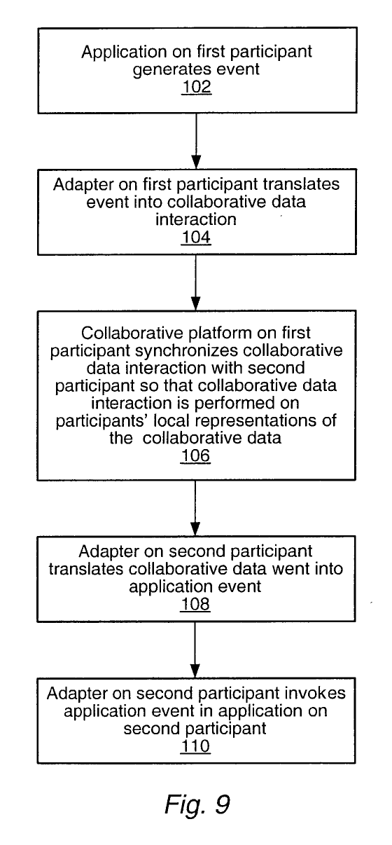

FIG. 9 illustrates a method for data-centric collaboration among a plurality of participants. An application on a first participant may generate an event, as indicated at 102. For example, a user of the application may indicate in the application that a change is to be made to the collaborative resource where a non-user based process may have an eternal event affecting the collaborative resource. An adapter on the first participant may receive notification of the application event and translate the event into a collaborative data interaction, as indicated at 104. The adapter may then invoke the corresponding collaborative data interaction in the collaborative platform on the first participant. The collaborative platform on the first participant may synchronize the collaborative data interaction with a second participant (and possibly other participants) so that the collaborative interaction is performed on each of the participants' local representations of the collaborative data resource, as indicated at 106. An adapter on the second participant (and possibly other participants) may receive notification of the collaborative data event and translate the collaborative event into an application event for the application on the second participant, as indicated at 108. The adapter on the second participant may then invoke the application event in the application on the second participant, as indicated at 110, thus reflecting the change made to the collaborative resource by the application on the first participant in the application on the second participant.

The collaborative platform provides networking and management (e.g. through a network engine and kernel) of collaborative resources. Thus, an application may become a collaborative application by being layered with the collaborative platform. Since the collaborative platform handles the networking and management of the collaborative resources, an application may be designed with little or no thought given to networking and collaboration and yet become a fully collaborative application once layered with the collaborative platform. Existing applications, such as applications designed for single user use only or for use in a non-collaborative network, may become collaborative once interfaced to the collaborative platform.

The collaborative platform allows collaboration between different applications to occur at the data or metadata level within collaborative resource objects. An application interfaced to the collaborative platform may access the collaborative data resource representations managed by the collaborative platform and thus become a collaborative application. In one embodiment applications may interface to a collaborative platform and thus to collaborative resources by using an adapter which translates application level interactions into modifications within the collaborative environment to the collaborative data and vice versa. An adapter may make use of an externally visible API provided by the application (such as COM or JavaScript methods) to interface between the application and the collaborative platform. Most modern applications already support such an API. If such an externally visible API is not present in the application, the application may be modified to notify the collaborative platform of events within the application.

For applications providing an external API, an adapter for the application's API may be used to interface the application to the collaborative platform in order to allow the application to participate in a collaborative environment. By using an externally available API as an interface to the collaborative platform, an existing application may be provided a means of interfacing with other collaborative resources including representations of collaborative resources that may be modified in a collaborative environment.

By interfacing an application on a device to the collaborative platform on the device (such as through the use of an adapter for the applications external API), the application may participate in a collaborative environment with other applications on other devices. The collaborative platform on each participant provides a collaborative resource abstraction from each participant application so that each application does not need to be aware of or know how to communicate with any other application. Furthermore, the collaborative platform allows collaboration on one or more collaborative resources by different types of applications on different types of devices. For example, a graphical presentation application, a spreadsheet application, and a database application may all collaborate together on the same collaborative resource data. Each application may be located on the same or a different participant device and an adapter may provide the interface between each application and the collaborative environment. Thus, the collaborative platform may provide for cross application collaboration and may support collaboration in heterogeneous computing environments. For example, supercomputers, gaming consoles, desktops, laptops, and PDA's may all be connected in a single collaborative environment. When a collaborative resource is modified by one participant application, the changes are represented to all other participants.

An adapter allows an otherwise single user application to load, manipulate, and display collaborative resources. Adapters for a particular type of collaborative resources, regardless of the application layer they were built for, may provide a common interface for the collaborative platform to communicate with applications. Thus, multiple types of adapters may be present in the collaborative environment all collaborating with the same collaborative resources and facilitating interoperable collaboration between different applications.

The collaborative platform may allow the spontaneous creation of collaborative groups by entering into a session with other participants. During collaboration new content, new applications, new participants, and new resources may all be added at any time through the management of server and client data representations by the collaborative platforms of each participant. Because the collaborative platforms provide an abstraction of the collaborative resources from the participant applications, the interactions (e.g. view) with the collaborative resources may be different for each participant. For example, a collaborative environment may have three different types of participants: a database, a desktop PC running a spreadsheet application, and a PDA using a native spreadsheet program. The collaborative resource may be the spreadsheet data represented in one or more data representations. Each application may view the spreadsheet data differently and perform different types of modifications on the spreadsheet data. The collaborative platform for each participant application allows each participant application to view the spreadsheet data according to its own viewing capabilities and see changes made by the other participant applications. Thus, applications that are designed entirely independently of each other may be used together in the same collaborative environment.

As described above, the collaborative platform on each participant manages the distributed representations of each collaborative resource. The collaborative platforms synchronize changes to the collaborative resource between participants. The collaborative platforms may abstract this distributed collaborative data management from participant applications. From the perspective of the participant applications, it may appear as if each participant is accessing one central collaborative resource since the collaborative platform abstracts the distributed resource management from the participant applications. The collaborative platform may employ any suitable distributed data management and synchronization technique for managing the distributed representations of a collaborative resource. In one embodiment, each collaborative resource may have a host or server representation locally managed by the collaborative platform on one participant (the host participant for that collaborative resource). Each collaborative resource may be “shadowed” on other (non-host) participants such that a client representation is locally managed by the collaborative platform on each of the other participants participating in the collaboration. This embodiment is further described below.

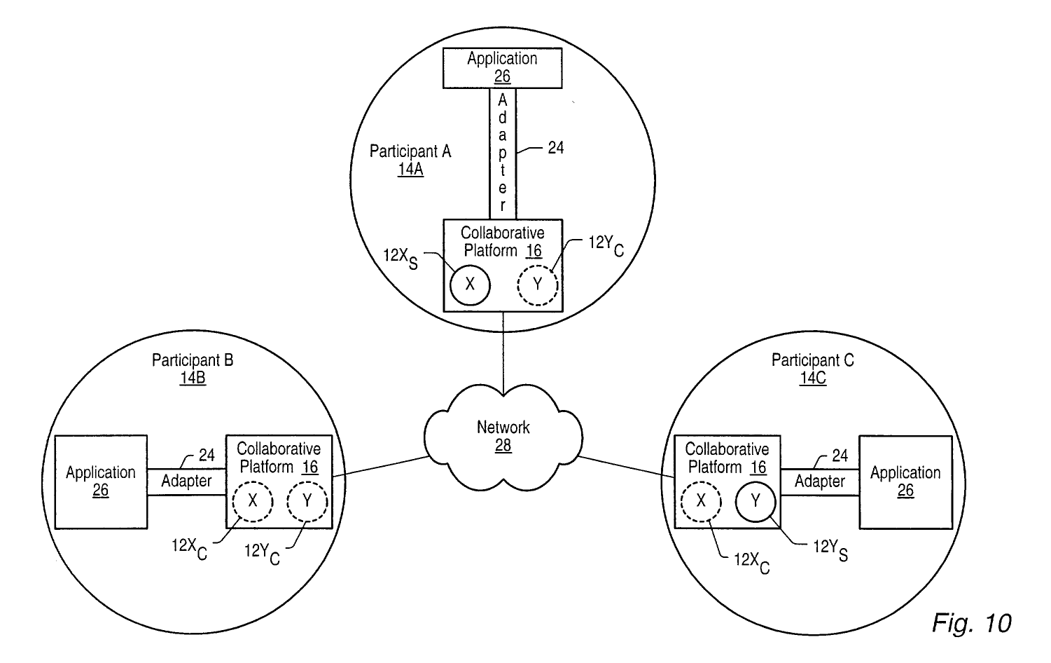

In the collaborative environment the collaborative platform for each participant may include a collaborative data resource representation for each collaborative data resource used in that collaborative environment. For each collaborative data resource, one of the participants' collaborative platform is the host or server for that collaborative data resource. The collaborative data resource representation managed by the host collaborative platform is referred to as the server data representation. Every other participants' collaborative platform manages a client data representation of that collaborative data resource. For example, FIG. 10 illustrates two collaborative data resources, collaborative data resource X and collaborative data resource Y. The server data representations are indicated by complete-line circles and the client data representations are indicated by dashed-line circles. Thus, server data representation 12X_{S} is managed by collaborative platform 16 on participant A and the collaborative platforms on participants B and C include client data representations of collaborative data resource X (client data representations 12X_{C}). Server data representation Y is managed by the collaborative platform on participant C (server data representation 12Y_{S}) and client data representations of collaborative data resource Y are managed by the collaborative platforms of participants A and B.

In one embodiment, when an application makes a change to a collaborative data resource, the change is made for the server data representation and then the collaborative platform managing the server data representation sends state information to each client data representation of that collaborative data resource to reflect the change made to the server data representation. For example, the application 26 of participant A may make a change to server data representation 12X_{S}. The collaborative platform on participant A may execute a command to make the change to server data representation 12X_{S} and then send updated state information for collaborative data resource X to the collaborative platforms of participants B and C. The collaborative participants B and C update their respective client data representations 12X_{C} in response to the state information received from participant A.

In one embodiment, if a participant having a client version of a collaborative data resource desires to make a change to that collaborative data resource, a command or message indicating the desired change is sent to the participant having the server version of the collaborative data resource. The change is made on the server data representation and then state information is sent to each other participant to update the client data representations corresponding to the server data representation. For example, if the application of participant B indicates a change to collaborative data resource X, the collaborative platform of participant B sends a command or message to the collaborative platform of participant A where the server data representation X is located. The change is made to the server data representation X on participant A and then the collaborative platform of participant A sends a state update to participants B and C to update the client data representations of collaborative data resource X.

Within a collaborative environment each participant has a data representation, either server or client, of each collaborative data resource. For each collaborative data resource, one of the participants manages the server data representation and a client data representation of that collaborative data resource is located on each of the other participants. A participant may create a new collaborative data resource by adding a server data representation of that collaborative data resource to its collaborative environment and sending a client data representation of the new collaborative data resource to each other participant. When a new participant joins a session, it may receive a client data representation of each collaborative data resource in the session. Also, a new participant may send each other participant a client data representation of each of its collaborative data resources upon joining a session.

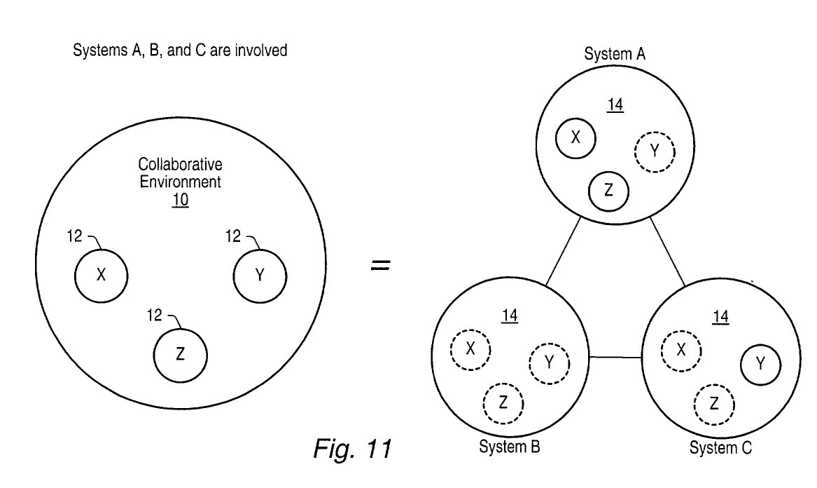

FIG. 11 illustrates how a collaborative environment 10 is created by the collaborative resource abstraction in which each participant has a server or client data representation of the collaborative resources. As illustrated on the right side of FIG. 11, system A manages server data representations X and Z and includes a client data representation Y. System B has client data representations X Y Z, and system C manages server data representation Y and client data representations X and Z. The collaborative platforms on each participant manage and synchronize collaborative data resource representations to create a collaborative environment 10 illustrated on the left side of FIG. 11 in which the participants may collaborate on collaborative resources (e.g. collaborative resources X, Y, and Z). The left side of FIG. 11 illustrates the collaborative environment as it appears to the participant applications, whereas the right side of FIG. 11 illustrates the actual distributed representations managed at each local collaborative environment.

The collaborative platform may allow applications to participate in a distributed collaborative network environment. Although the collaborative platform at each participant may hide the distributed nature of the collaborative environment from its respective local application(s), collaborative resource data representations may exist in some capacity in each local environment. The distributed platforms control and coordinate interactions between the local data representations. Each collaborative platform participates in a distributed system to represent structured, collaborative data objects and to provide a layer of abstraction, such that participant applications can access, and interact with, the collaborative data objects without knowledge of their distributed nature.

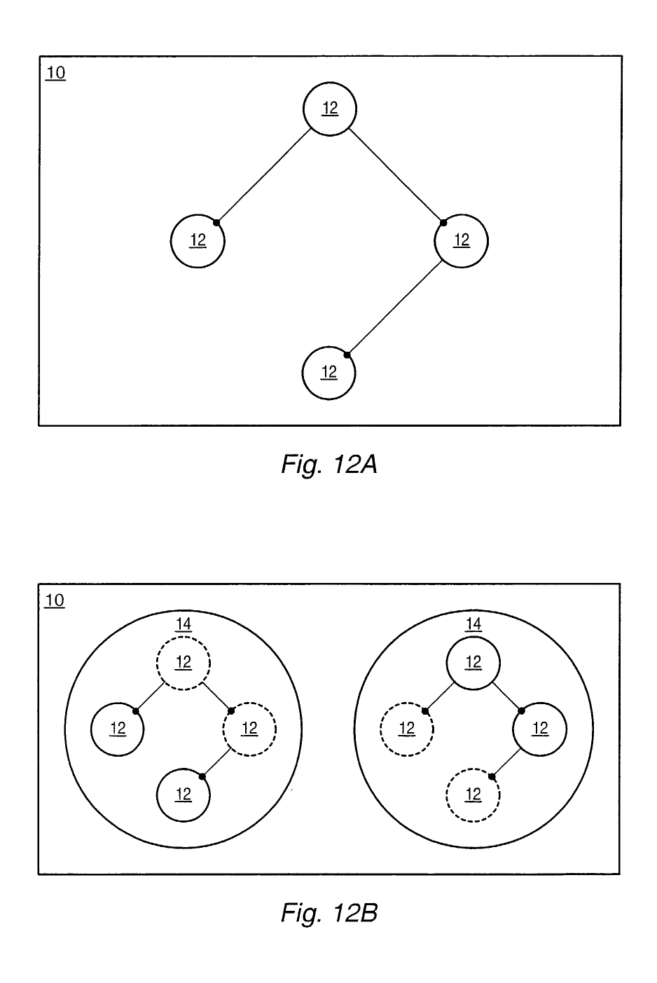

Each local collaborative data representation may represent structured collaborative data. For example, a collaborative resource may be structured according to a directed graph, and structured data relationships may exist between collaborative data objects. FIG. 12A illustrates a unified visualization model of structured collaborative data as it may conceptually exist in the collaborative environment. This is how a participant application may see the collaborative data. Due to the abstraction provided by the collaborative platform, to a participant application data objects have a singular, unified representation in the collaborative environment. FIG. 12A shows an example of a collaborative environment 10 including four collaborative data objects 12 as it might be seen from the perspective of participant applications. The data objects 12 may be organized in some structured fashion corresponding to the relationships between the underlying collaborative data's structure. The structure may have been set up by a participant application, for example. A relation between collaborative data objects is represented in the figures by a line connecting them with a small dot to denote the direction of the relation.

FIG. 12B illustrates structured collaborative data as it may exist physically in the collaborative environment. Each collaborative data object may have a unique representation in each local environment. FIG. 12B illustrates an example of a collaborative environment 10 including four collaborative data objects 12 as distributed to two local environments 14. The local environments 14 may be connected through some network mechanism 28. Each local environment contains distinct collaborative data object representations 12. Each distinct collaborative data object representation in a local environment corresponds to a single collaborative data object representation in each other local environment to which it is connected. The structure of the collaborative data as it exists in the collaborative environment is preserved in each local environment. Each participant's collaborative platform maintains each data object in its local environment as a unique entity, while maintaining the structured relationships across each local environment in the distributed network.

Each local collaborative data object representation may have two main characteristics: its state (or, the state of the data that it represents), and its type. Its state is the state of the underlying data, for example just as it might exist in a non-distributed, non-collaborative environment. Its type indicates what role it plays in coordinating the accesses and interactions of the participant application with the collaborative data object. In one embodiment, a local collaborative data object representation may have two mutually exclusive types: it may be a server representation, or it may be a client representation.

The collaborative platform hosting a server representation may be responsible for coordinating the accesses and interactions of the participant application with the collaborative data resource object represented by the server representation. In one embodiment, only one representation of a collaborative data resource object in the distributed collaborative environment may be a server representation. All other representations of that collaborative data resource object are client representations. Each collaborative platform hosting a client representation may be responsible for relaying requests for accesses and interactions from its participant application(s) to the server host. Thus, each client representation may have a corresponding server host. The client representations are thus clients of their server representation, relaying requests and receiving responses, in the form of interaction requests and state changes, respectively. In this way, the server-client relationship may maintain a uniform representation of the collaborative data object across the distributed network. Therefore, each individual local participant application may see the same synchronized state of the data.

If, for some reason (e.g. a lost network connection), a client representation becomes disconnected from its server host and is unable to become a server representation itself, the client representation may then be a disconnected representation. Disconnected representations may no longer be able to function in the collaborative environment, as they may have no way to relay access or interaction requests since they have no known server host, and they have no way to process these requests themselves, as they are not themselves server representations.

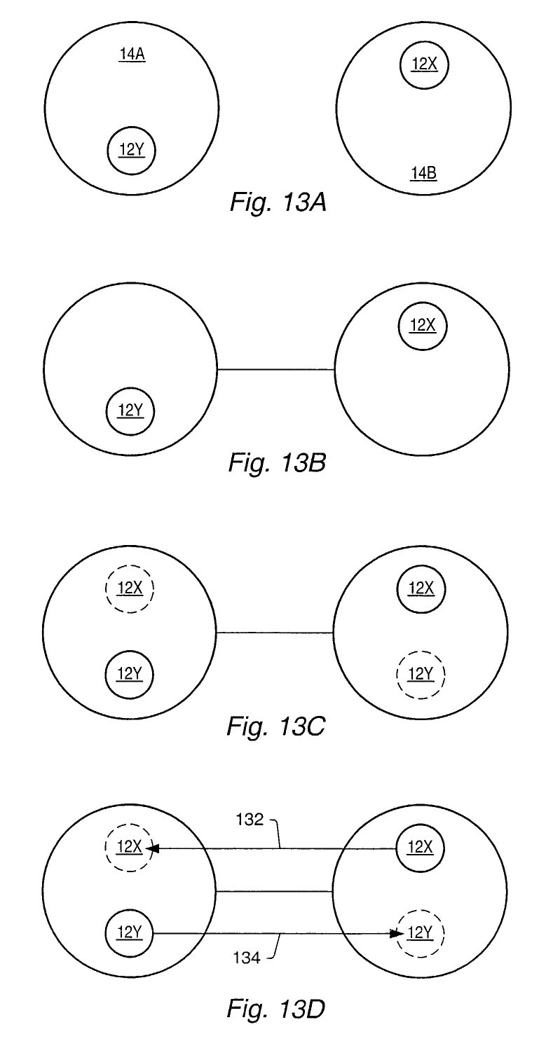

FIGS. 13A-13D illustrate the establishment of a new collaborative session between a plurality of participants. FIG. 13A illustrates two participants 14A and 14B not currently connected for collaboration. Thus, two separate local environments exist, each one having a local resource. Participant 14A includes a local resource 12Y and participant 14B includes local resource 12X. No collaborative environment is currently established for the resources 12X and 12Y. If the participants wish to collaborate on the resources, a session may be established between the two local environments, as illustrated in FIG. 13B. Each participant may host the server representation of the resource it had prior to establishing the session and send a client representation to the other participant. Thus, once a session is established, client representations corresponding to each resource are injected or created at the non-host participant, as illustrated in FIG. 13C. In one embodiment, a complete state of the server representation is sent from the host of the server representation to the other participant to create a new client representation, thus creating a client representation on the other participant that makes the full state of the corresponding collaborative resource available to both participants in a collaborative environment. Changes to the collaborative resource are synchronized by the server representation for each collaborative resource, as illustrated by arrows 132 and 134 in FIG. 13D. In one embodiment, after the client representations are initially created, future state updates will not typically involve transmitting the complete state of the server representation. In one embodiment, later state updates may only transmit a delta. Thus, state changes to a collaborative resource may be synchronized by the server representation only sending a representation for the data that has changed (including added and deleted data) to the client representation(s).

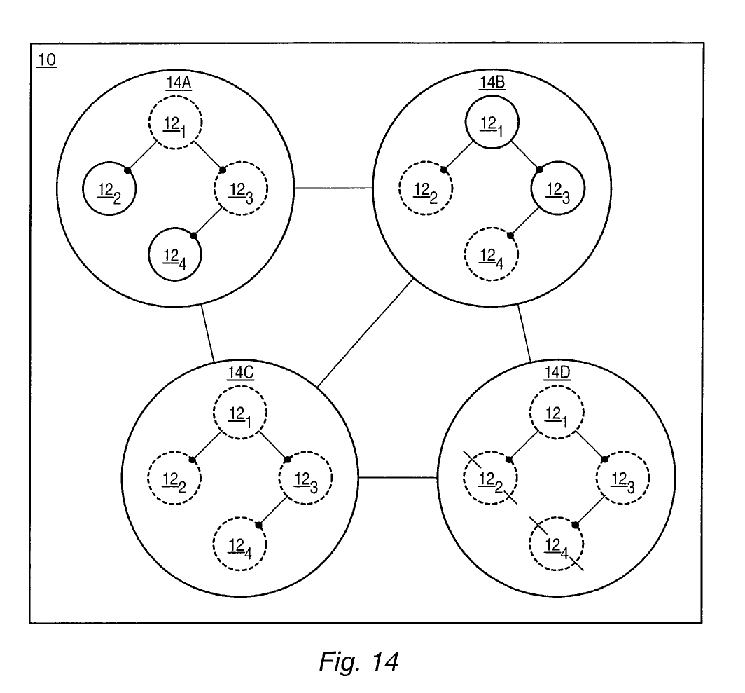

FIG. 14 illustrates four local environments 14A-14D participating in collaborative environment 10. In this embodiment, the local representations of the collaborative data objects are structured the same in each local environment. However, the type characteristic of the local representations may differ from local environment to local environment. Each collaborative data object has one server representation (shown as a solid circle) on one of the local environments. For example, the server representations for collaborative data object 12₂ and 12₄ are hosted in local environment 14A and the server representations for collaborative data objects 12₁ and 12₃ are hosted in local environment 14B. Client representations (shown as dashed circles) of each collaborative data object are located at non-host local environments. For example, local environments 14A, 14C and 14D all include local client representations of collaborative data objects 12₁ and 12₃. Note that local environments may include a mix of both server and client representations. Other local environments may include only client representations, such as local environment 14C, or only server representations. A local environment may also include disconnected representation (shown as dashed circles with slashes through them) which are local collaborative data object representations that have become disconnected from their server counterparts. For example, local environment 14D does not have (or may have lost) a network connection to local environment 14A that hosts the server representations of collaborative data objects 12₂ and 12₄. Thus, the local representations of collaborative objects 12₂ and 12₄ in local environment 14D are disconnected representations. In some embodiments, the disconnected representations may still be viewed in their local environment, but may no longer be able to participate in the collaborative environment. Note that for a local client representation to participate in the collaborative environment, it need only have a connection to the participant hosting the server representation of that collaborative object.

Modifications made to the state of collaborative object representations may be coordinated among the representations. In one embodiment, the server representation (or collaborative platform hosting the server representation) has the responsibility to coordinate interactions with counterpart data in any given local environment. The server representation (and/or host platform) acts as a server to the corresponding client representations to coordinate a dynamic synchronization process for a given collaborative object. Below are some examples of how the client-server behavior of server and client representations, when combined with peer-to-peer communication between networked local environments may work together to provide data-centric collaboration.

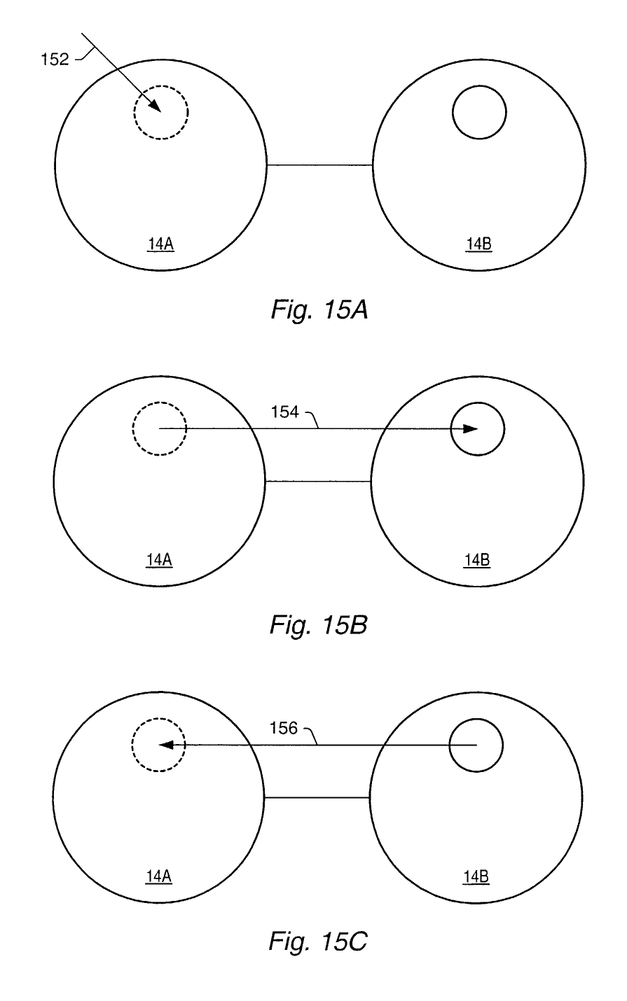

FIGS. 15A-15C illustrate one embodiment of a process for synchronizing a modification to a client representation. A participant application in a local environment 14A hosting a client representation of a collaborative data object may initiate a modification to the state of the client representation, as indicated by arrow 152 in FIG. 15A. For example, an adapter coupling the participant application to a collaborative platform for the local environment may detect a change event from the application and translate the event into a collaborative data interaction modification request. Since the collaborative data representation in the application's local environment is a client type, before the modification request is committed to the client representation, it is relayed to the server representation of the collaborative object in a different local environment 14B, as indicated by arrow 154 in FIG. 15B. The state change request may be relayed via a message, command or other communication made over some network mechanism connecting the two local environments. The server representation may then process the request and broadcast a corresponding state update to any connected client representations, as indicated by arrow 156 in FIG. 15C. For example, a collaborative platform for the local environment hosting the server representation may receive the message indicating the collaborative data interaction and perform the corresponding state change in the server representation and then broadcast the message indicating the collaborative data interaction to all connected local environments having a client representation of the collaborative object. In one embodiment, a collaborative platform for each local environment receiving this broadcast message from the host of the server representation may then commit the state change to its respective client representation. Note that in addition to sending the state change back to the client representation that initiated the state change, the state change may also be sent to all other client representations (if any) of that collaborative object in the collaborative environment.

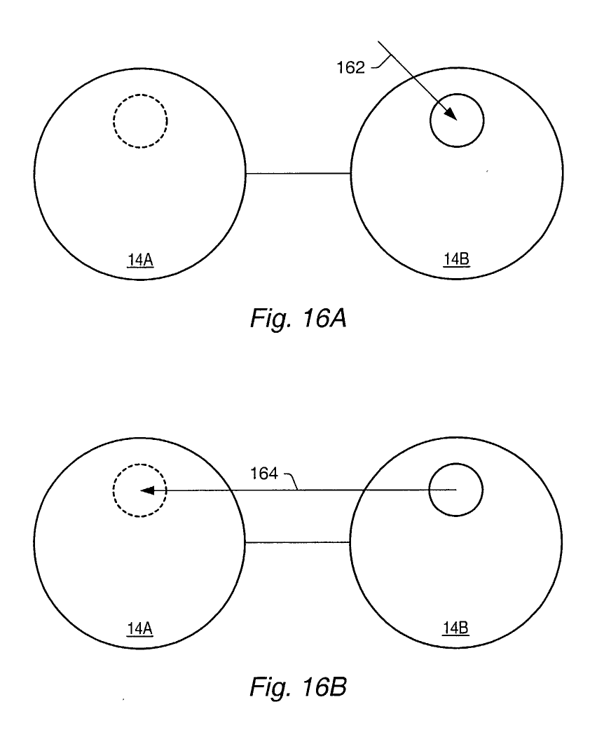

FIGS. 16A-16B illustrate one embodiment of a process for synchronizing a modification to a server representation. A participant application in a local environment 14B hosting a server representation of a collaborative data object may initiate a modification to the state of the server representation, as indicated by arrow 162 in FIG. 16A. For example, an adapter coupling the participant application to a collaborative platform for the local environment may detect a change event from the application and translate the event into a collaborative data interaction modification request. Since the collaborative data representation in the application's local environment is a server type, the state change may be immediately made in the server representation. The state change is also relayed to any connected client representations, as indicated by arrow 164 in FIG. 16B. In one embodiment, a collaborative platform for each local environment receiving this broadcast message from the host of the server representation may then commit the state change to its local client representation.

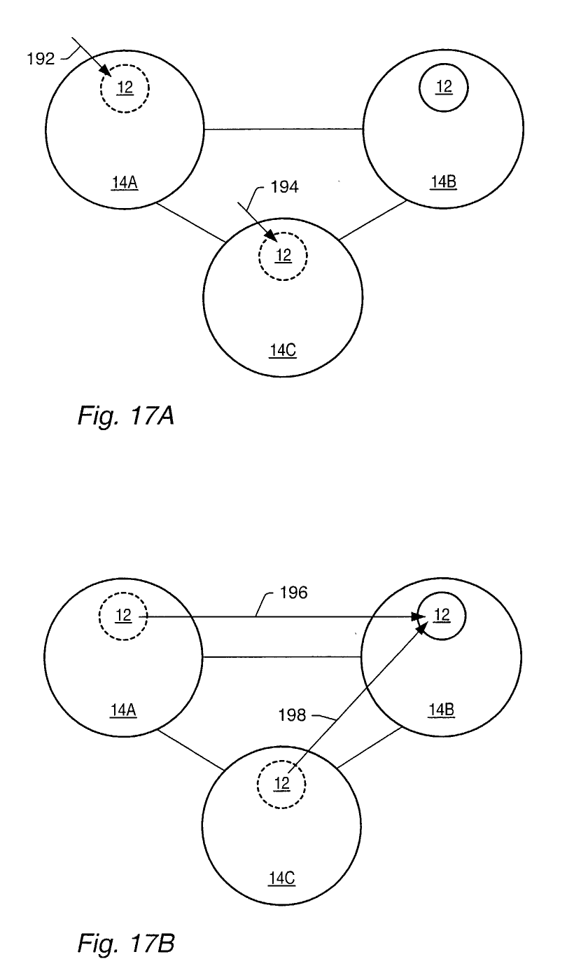

FIGS. 17A-17D illustrate how conflicting state changes to a collaborative resource may be arbitrated and resolved by the server representation. Sometimes conflicting changes may occur at different remote locations, before the resulting state from one interaction or the other can be synchronized in all local representations. For example, an application may modify the state of a client representation of collaborative resource 12 in the local environment of participant 14A, as illustrated by arrow 192 in FIG. 17A. Around the same time another application may modify the state of another client representation of the same collaborative resource 12 in the local environment of participant 14C, as illustrated by arrow 194. Since, in both cases, the local representation in the application's local environment is a client representation, both modification requests are relayed to the server representation of the collaborative resource in the local environment of participant 14B, as illustrated by arrows 196 and 198, respectively, in FIG. 17B.

The server representation (or its collaborative platform) may then process the requests. In one embodiment, the host of the server representation will rebroadcast the two corresponding state updates in the order that they were received to any connected client representations. For example, if the modification request from participant 14C was received first, it is broadcast to all client representation by the server representation as illustrated by arrows 200 and 202 in FIG. 17C. Then the request modification from participant 14A is broadcast to all client representation by the server representation as illustrated by arrows 204 and 206 in FIG. 17D. In other embodiment, instead of processing collaborative resource state changes on the FIFO (First In First Out) basis described above, a priority or other arbitration scheme may be employed by the server representation to synchronize collaborative resource state changes.

In one embodiment, when the server representation receives a collaborative resource state change request from a client representation, it broadcasts the state change to all client representations including the client representation that originated the request. Even though the client representation that originated the change may have already been updated when it made the request to the server representation, the server representation may still send the state change back to the originating client representation to maintain synchronization across the various distributed representations of the collaborative resource. When the client representation that originated the change receives the state change back from the server representation, it knows that the change has been accepted by the server and broadcasts to all other client representations of the collaborative resource. In one embodiment, the client representation may maintain a prior state until it receives this confirmation in case it needs to revert back to the prior state. In another embodiment, a client representation originating a state change may not change its own state until it receives the state change back from the server representation. By broadcasting state updates to all server representations (including the server representation that initiated the change) race conditions for state updates may be avoided so that the state of the local representations of a collaborative resource will remain synchronized.

If a server representation rejects a collaborative resource state change request from a client representation (e.g. due to lack of permission or some other reason), the server representation may send a reject message back to the client representation that originated the request. In another embodiment, the server representation may send a state change back to the originating client representation which negates the change initiated by that client representation. Note that in the situation of the server representation rejecting a client originated state change, the reject message or state change may be sent back to only the client representation that originated the rejected change.

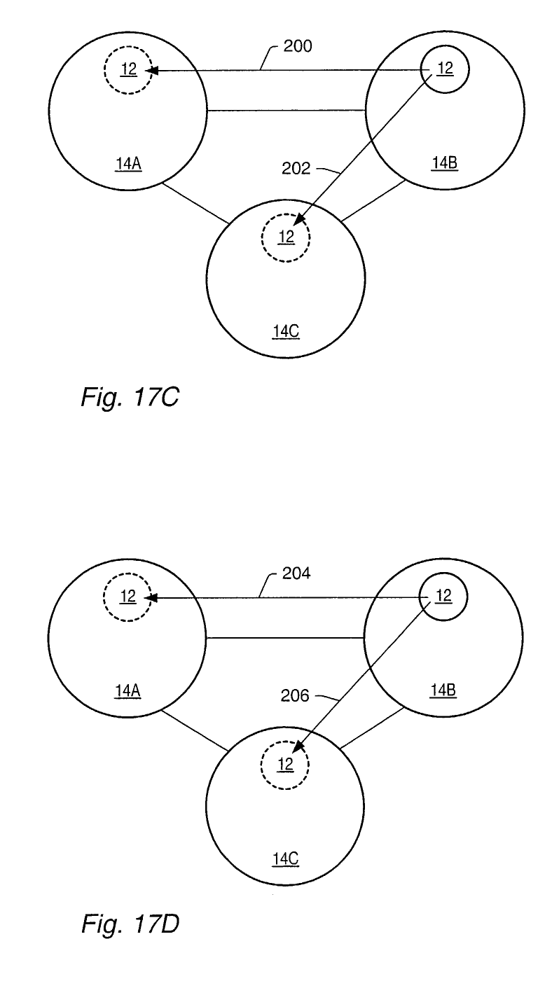

FIGS. 18A-18F illustrate one embodiment of a process for synchronizing a modification that affects multiple representations. A participant application in a local environment 14B hosting a server representation of a collaborative data object 12X may initiate a modification to the state of the server representation, as indicated by arrow 172 in FIG. 18A. For example, an adapter coupling the participant application to a collaborative platform for the local environment may detect a change event from the application and translate the event into a collaborative data interaction modification request. The modification to the server representation may require interacting with another representation 12Y, as indicated by arrow 174 in FIG. 18B. For example, the two collaborative object representations may be structurally linked such that the modification in the first collaborative object 12X requires a modification to the second collaborative object 12Y. Thus, a state change interaction for the second collaborative object may be generated. If the second collaborative object representation 12Y in the application's local environment is a client type, then before this modification request is committed to the client representation, it is relayed to the counterpart server representation of the collaborative object in a different local environment 14A, as indicated by arrow 176 in FIG. 18C. The state change request may be relayed via a message, command or other communication made over some network mechanism connecting the two local environments.

The server representation of the second collaborative object 12Y may then process the request and broadcast a corresponding state update to any connected client representations (including the client representation from which the state update originated), as indicated by arrow 178 in FIG. 18D. For example, a collaborative platform for the local environment 14A hosting the server representation of the second collaborative object 12Y may receive a message indicating the collaborative data interaction and perform the corresponding state change in the server representation 12Y and then broadcast the message indicating the collaborative data interaction to all connected local environments having a client representation of the second collaborative object 12Y. A collaborative platform for each local environment receiving this broadcast message from the host of the server representation may then commit the state change to its respective client representation of the second collaborative object 12Y, including local environment 14B that originated the state change. The local environment 14B that originated the state change may then complete the initial modification to the server representation of the first collaborative object 12X, as indicated by arrow 180 in FIG. 18E. Finally, the state change for the first collaborative object 12X is relayed to any counterpart client representations, as indicated by arrow 182 in FIG. 18F.

Collaboration may be extended by each participant by the addition of new collaborative objects into the collaborative environment. Since the collaborative platforms handle the network and collaborative synchronization of the collaborative resources, the participants' users or developers may be free to focus on content creation rather than networking and collaboration support. Furthermore, since different types of applications and devices may interface to the collaborative environment (e.g. through adapters) a collaborative resource may be shared among the participants independently of the operating systems, input devices, display geometries, graphical libraries, etc. of each participant.

A participant may add a new collaborative data resource into the environment of which other participants were previously unaware. The collaborative platform of a participant adding a new collaborative data resource may inform the other participants' collaborative platforms of the new collaborative data resource and provide representations of the new collaborative data resource to the other participants' collaborative platforms. Thus, the collaborative platform may allow for dynamic content contribution where objects are added into the collaborative environment regardless as to whether other participants have any knowledge of the object. For example, in one embodiment a newly added collaborative data resource may be a Java object. The local participant adding the object has in its local environment the Java .class definition of the object being added. When adding the new object to the collaborative environment, the local collaborative environment may verify that participants also have a .class definition of the object. If not, the local collaborative platform may provide the .class file(s) to participants lacking the object definition. Alternatively, upon receiving a representation of the added object (e.g. upon receiving a client data representation), a participant lacking a .class definition of the object may request the object host to provide the .class definition. Upon receiving such a request, the host participant (e.g. injection participant) may send a class file(s) for the object to the requesting participant. The example of a Java object is merely illustrative. In other embodiments, any type of content may be dynamically added to the collaborative environment and the collaborative platform may support providing other information needed by participants to recognize or use that added content. Thus, content previously unknown and/or unrecognized by one or more participants may be dynamically added to the collaborative environment and used by all participants. In environments having large numbers of participants, one or more of the participants is likely to have complete knowledge of added content. The dynamic content contribution provided by the collaborative platform may allow content to be added and used in the environment in such embodiments.

In some embodiments, client data representations of a collaborative data resource may differ from the server data representation according to the environment in which they are located. A collaborative data resource representation's behavior may be dictated by or customized for its local environment. For example, the amount of bandwidth a collaborative data resource representation uses or the amount of processing a collaborative data resource representation performs or requires may be adapted to its environment. A client data representation on a device may support behaviors adapted to the capabilities of the local environment. A client data representation on a device with a slow modem connection may try to minimize network use. Different embodiments may employ different mechanism for adapting collaborative data resource representations to their environment. For example, the host participant may determine or receive information regarding a participant and send a client data representation adapted for the capabilities of that participant. Thus, a PDA participant may received a “scaled down” client data representation. In embodiments following the command-behavior paradigm described herein, the local command-behavior linking for a collaborative data resource representation may be adjusted according to the local environment.

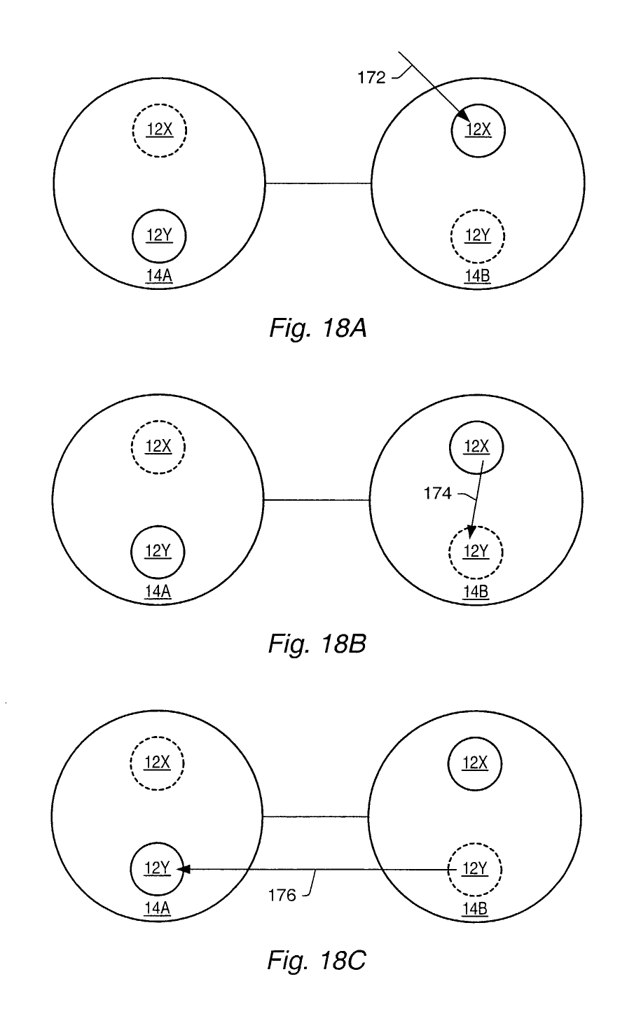

In a collaborative environment multiple different collaborative data representations may all represent the same collaborative data resource. FIG. 19 illustrates the connection between collaborative data representations that represent the same collaborative resource. The relationships between such collaborative data representations may be referred to as the connection graph for a collaborative data resource. FIG. 19 illustrates a connection graph a for a collaborative resource 12X. In one embodiment the connection graph for a collaborative resource may have a star-shaped topology with the server representation 12X_{S} at the center and each client representation 12X_{C} logically connected to the server representation. In such an embodiment each client representation may be connected to exactly one server representation, and the one server representation may be logically connected to all of the client representations. FIG. 19 illustrates a connection graph representing four local collaborative environments in which three environments include client representations 12X_{C} which are all connected to the local environment having the sole server representation 12X_{S}. Each connection may be bi-directional so that each local environment may receive and send collaborative resource update communications. A collaborative resource may have only one connection graph at any given time.

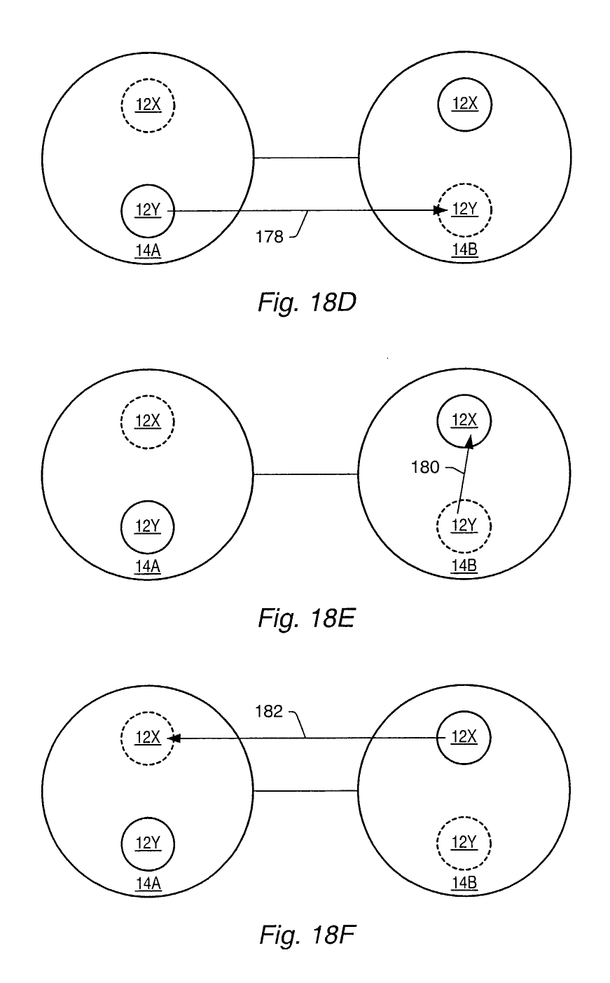

FIG. 20 illustrates four local environments 14A-14D in a collaborative environment 10. Each local environment may be connected to one or more other local environments according to a session graph. FIG. 20 illustrates a session graph in which each local environment is connected to every other local environment. This may be referred to as a fully connected session graph. Local environments may also be connected in session graphs which are not fully connected. For example, referring to FIG. 19, the connection between local environment 14A and local environment 14B may not be present. A local environment that is not fully connected may be limited in it's ability to participate in the collaborative environment.

Referring back to FIG. 12A, each collaborative data resource may be related to one or more other collaborative data resources according to a relation graph. FIG. 12A illustrates a collaborative data resource relation graph in which the relation between collaborative data objects is represented by a line connecting them with a small dot to denote the direction of the relation. The same relation graph may exist for the local representations of the collaborative data objects in each local environment.

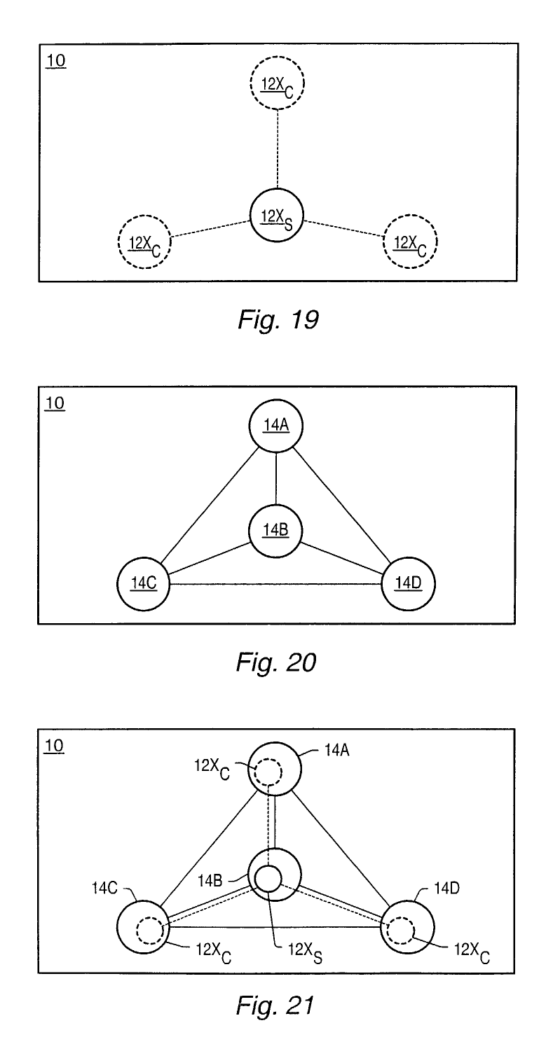

FIG. 21 illustrates a collaborative resource's connection graph superimposed over a session graph for participants in a collaborative environment 10, according to one embodiment. As illustrated by FIG. 21, the collaborative environment may employ a hybrid of both client-server and peer-to-peer properties. FIG. 21 illustrates a collaborative environment having one collaborative resource; however, it is made up of four discrete systems, and so there are four discrete representations of the collaborative resource—one in each local environment. In one embodiment, if multiple collaborative resources were present in the collaborative environment, a relation graph for the collaborative resources may also be superimposed on the session graph so that the local collaborative resource representations have the same relationship graph in each local environment. A collaborative platform and the collaborative resource representations themselves may maintain the connection, session and relation graphs.

In one embodiment, the collaborative platform may provide for mutability regarding the type characteristic (server or client) of the representation of a collaborative resource within the collaborative platform. As described herein, a collaborative resource may be hosted by one participant's collaborative platform (as a server data representation) and reflected in each other participant collaborative platform (as a client data representation). Mutability allows the collaborative resource to be dynamically re-hosted from one participant to another. For example, suppose a collaborative resource exists as a server data representation on system A and a client data representation on system B. Mutability provided by the collaborative platforms allows the server data representation on system A to become a client data representation, and the client data representation on system B to become a server data representation. Mutability may provide for load balancing and/or transparent fail over protection within the collaborative environment. For example, the participant hosting the server data representation of a collaborative data resource performs changes and modifications to the collaborative data resource requested by itself or by other participants and then reflects the state of those changes to the other participants. If the host participant becomes overloaded and lacks the resources to continue hosting a collaborative data resource, it may request that another participant mutate its client data representation of that collaborative data resource into the server data representation and it may mutate its server data representation of the collaborative data resource into a client data representation.

As described above, mutability is the ability of a collaborative resource representation to mutate, or to change its type. In one embodiment, a collaborative resource representation's type may change in one of three ways: if it were the server representation, it may mutate into a client representation; if it were a client representation, it may either mutate into the server representation or become a client representation with different a server host. Mutation may refer to a collaborative resource representation changing its role in the collaborative environment.

An existing server representation may become a client representation or may become inaccessible to the other representations, and in response, one of the existing client representations becomes the server representation. A mechanism may be employed to arbitrate which representation will become the server representation. In one embodiment, all representations may agree on which representation is to become the new server representation. By way of this agreement, the connection graph for the collaborative resource may remain synchronized across all representations in the session graph. In one embodiment, the representation or local environment initiating the mutation may designate which representation is to become the server representation and all local environments in the session graph may be notified of the designation so that local environment may update its connection graph for the collaborative resource.

In another embodiment, connection graph agreement may be accomplished through the use of a mutation list. A mutation list may be a list of representations for a particular collaborative resource that are in line to become the server representation. In one embodiment, each local environment or representation may have a copy of the list. In one embodiment, the list may be kept synchronized by the current server representation (or its collaborative platform). When a mutation is initiated, the new server representation will be the first one on the list. The identity of that representation may then be removed from the top of the list, when it becomes the new server representation. The old server representation (if it is still present in the collaborative environment as a client representation) may or may not be placed back onto the list of representation next in line to become the server representation. The collaborative resource connection graph may be updated at each local environment so that each collaborative resource representation will perform its proper role in the collaborative environment, e.g. to synchronize collaborative resource state changes between participants. Some examples of mutation are further described below.

In some situations a local environment or application may wish to initiate mutation of a collaborative resource. For example, a participant may wish to transfer control (e.g. host responsibility) of a collaborative resource to another participant.

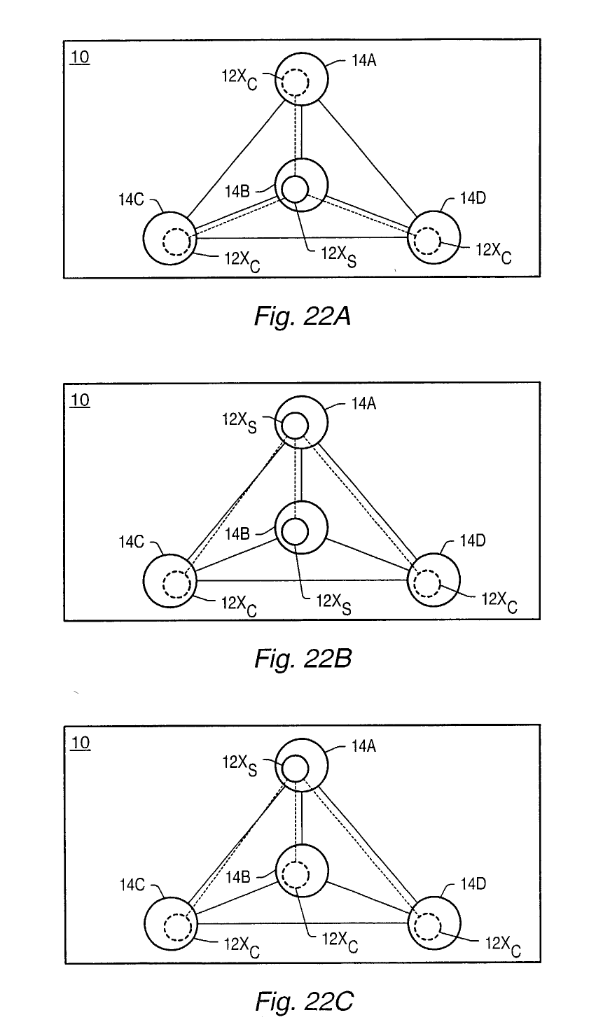

FIGS. 22A-22C illustrates an example of a host participant initiating a mutation to transfer server host responsibility for a collaborative resource to another participant. Referring to FIG. 22A, participant 14B may be the host participant for collaborative resource 12X and its local environment includes a server representation 12X_{S} of the collaborative resource. The current server representation 12X_{S} may signal a mutation to the other representations. The current server representation may designate which representation is to become the server representation, or the first representation identified on a mutation list may become the new server representation. In embodiments employing a mutation list, all representations may have access to a synchronized copy of the list. Referring to FIG. 22B, one representation (on participant 14A) mutates to become the new server representation, and the other representations (including the previous server representation) mutate to establish connections with the new server representation, thus changing the connection graph for the pawn as represented by the dashed lines in FIGS. 22A-22C. The old server representation becomes a client representation itself, taking on the full client role, as indicated in FIG. 22C. Any communications such as state change requests received by the old server representation during the mutation process may have been held and then forwarded on to the new server representation once the mutation process is complete. In one embodiment, a collaborative platform (as described above) on each participant manages the mutation process for its respective local collaborative resource representations.

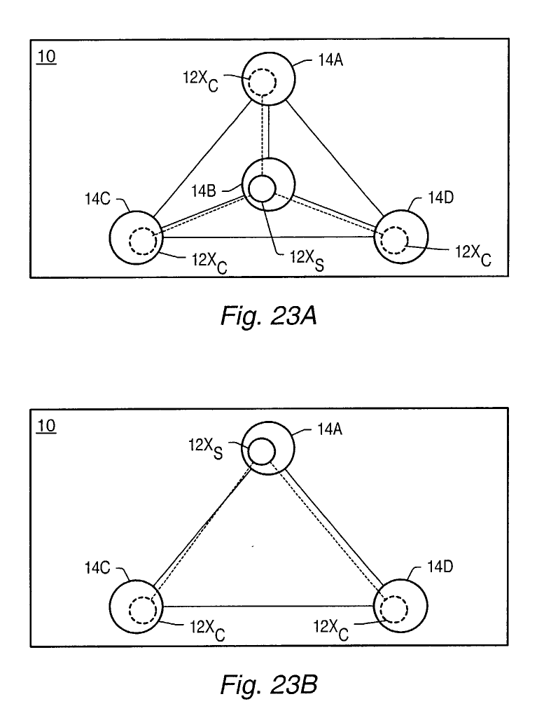

FIGS. 23A-23B illustrate another collaborative resource mutation situation that may occur when a server representation becomes disconnected from the rest of the session graph. For example, the current host participant 14B (in FIG. 23A) for a server representation may lose its network connection to other participants. The current host representation could also become disconnected if sessions managed by the collaborative platform on the current host participant 14B failed for some reason. Any type of communication link failure or system failure may result in the current server representation becoming disconnected or disappearing from the collaborative environment. The counterpart client representations of the now-disconnected former server representation may mutate to reestablish their connections with one of them taking on the role as server representation, as illustrated in FIGS. 23B. As discussed earlier, a synchronized mutation list may establish a way to arbitrate who becomes the new server representation, or if the old server representation has warning before it becomes disconnected it may designate the new server representation. The previous server representation no longer participates in the collaborative environment.

As discussed above, a mutation list may establish a way to arbitrate who becomes the new server representation. In the example of FIGS. 23A-23B the participant devices may each store a copy of or have access to a mutation list indicating an order for client representations to become the server representation in case connection to the current server representation is lost. For example, the mutation list in the example of FIGS. 23A-23B may be:

Participant 14A

Participant 14D

Participant 14C

When the sessions with the server representation on participant 14B were lost, the mutation list indicated that the client representation on participant device 14A should become the new server representation. Thus, if a current server representation becomes disconnected from the collaborative environment or ceases to function as a server representation, each participant (or participant's collaborative platform) may examine the mutation list to determine the new server representation. The participant indicated as the next host mutates its client representation into the server representation and the other participants form sessions of connections with the new server representation. The new host participant may be removed from the mutation list. For example, the mutation list in FIG. 23B after participant 14A becomes the host of the server representation may be:

Participant 14D

Participant 14C.

Note that any form of ID may be used to indicate the participants on the mutation list. For example, the mutation list may be a list of network addresses, or universal unique identifiers, etc. The mutation list provides a mechanism to arbitrate changes in hosting a collaborative resource. When a current server representation is lost, the mutation list indicates how each remaining representation is to be mutated. The mutation list indicates which representation is to mutate into the new server representation, and the remaining representations remain clients but mutate to change their server connections to the new server representation.

The collaborative platform may support a forced mutation in which a user or object voluntarily requests to transfer the hosting of the collaborative data resource to another participant, as described for FIGS. 22A-22C above. As mentioned above, mutability may also provide transparent fail over within the collaborative environment to ensure that a collaborative resource is available even if the initially dedicated host of the collaborative resource leaves the collaborative environment. For example, a host participant may lose its network connection and thus no longer be present in the collaborative environment. A client data representation of the collaborative resource in one of the other participants may be mutated into the server data representation of the collaborative resource, such as described for FIGS. 23A-23B above. Thus, mutability allows a collaborative object to be dynamically re-hosted from one participant to another. The collaborative environment established by the collaborative platforms provides for dynamically changing the participant that is responsible for hosting or serving the collaborative resource to the other participants in the session. A fail-over mutation condition may also be supported in which the designated host of a collaborative data resource for some reason leaves the collaborative environment. In this case another participant may take over as the host participant for the collaborative resource. If a host participant has warning before it leaves the collaborative environment, it may designate another participant to take over as host. In some embodiments a mutation list for each collaborative data resource may be maintained within the collaborative environment indicating which participant should take over as host if the current host is no longer capable of hosting the collaborative data resource. Thus, in one embodiment each collaborative data resource may have a mutation list indicating an order of participants that may take over as host in case of disconnection of the current host. In case of disconnection of a collaborative data resource's host, the mutation list for that collaborative data resource may be read and a next host determined. If the next host participant indicated by the list is still present in the collaborative environment, its client data representation of that collaborative data resource may be mutated into the server data representation of the collaborative data resource. If the next host participant is no longer present in the collaborative environment another host may be determined from the list, e.g. according to an order of the list.

Mutability allows for collaborative resources to remain collaborative even if the host of the collaborative resource becomes disconnected from the other participants. Collaborative resources may be re-hosted transparently within the collaborative environment. A loss of connection and subsequent reconnection of participants may be handled seamlessly from the perspective of the participant applications. Fail-over handling may be transparent and automatic.

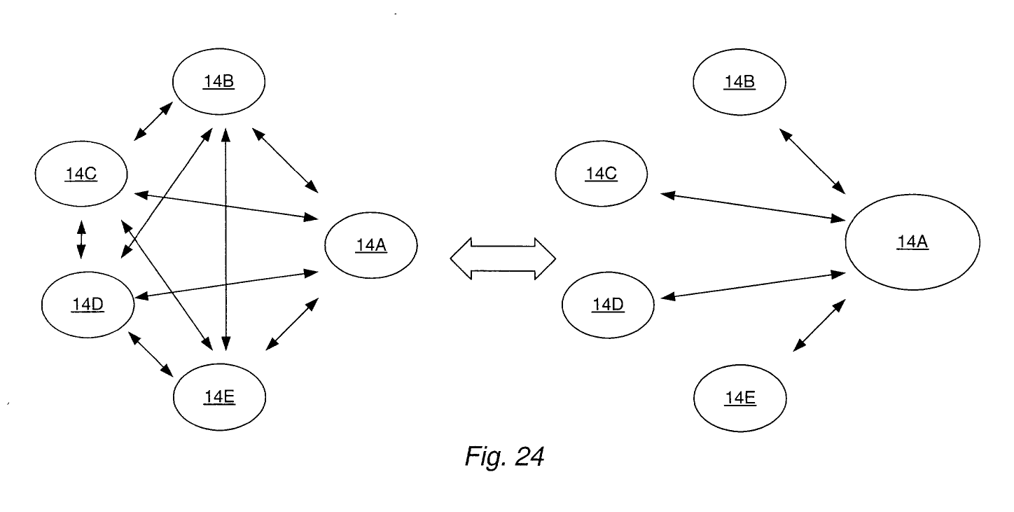

As mentioned above, mutability also allows the collaborative environment to shift between peer-to-peer and client-server collaboration models or a combination of both in real-time as demands on each participant change. FIG. 24 illustrates one collaborative environment on the left side of the figure in which many or all of the participants 14 may host different collaborative resources. For each collaborative resource, one of the participants hosts the server representation and the others have client representations. Several or all of the participants may host server representations of different collaborative resources. The arrows between participants indicate traffic or collaborative platform interactions between collaborative data representations on the participants. The arrows may represent communications for synchronizing state changes to the different collaborative resource.

If computing resources or network bandwidth become limited for a particular participant in the collaborative environment it may request that its server data representations be re-hosted on another participant. In some collaborative environments it may be desirable for high traffic collaborative data resources to be re-hosted on a central server. Some participants such as a PDA may lack the computing resources to effectively host a collaborative data resource. Such a participant may insert a new collaborative data resource into a collaborative environment and then request that it be re-hosted on a more powerful participant, for example. The right side of FIG. 24 illustrates the collaborative environment after all collaborative resources have been mutated to be hosted by participant 14A. Thus, the right side of FIG. 24 illustrates participant 14 hosting the server representations for all collaborative resources and the other participants having client representations.

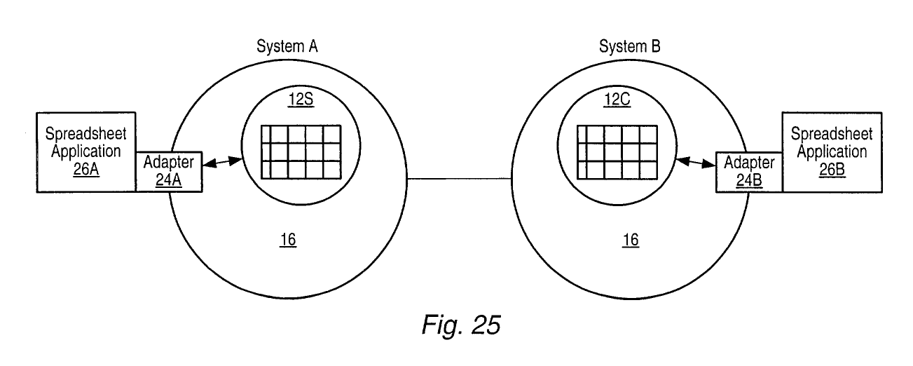

Turning now to FIG. 25 an example is illustrated in which a traditionally single user application, such as a spreadsheet application, is allowed to participate in a collaborative environment with another spreadsheet application. An adapter 24 may be provided to interface each spreadsheet application 26 to a collaborative platform 16 on each participant system. In one embodiment, the spreadsheet applications may support a COM API and the adapter may provide a COM-based interface between the collaborative platforms and the spreadsheet applications. The spreadsheet application 26 on each participant system may interact with a collaborative spreadsheet 12. The collaborative spreadsheet resource 12 may be maintained as a server data representation or group of server data representations 12S on one system and a client data representation or representations 12C on the other system. In FIG. 25, the collaborative platform of system A maintains the server collaborative spreadsheet data representation and the collaborative platform of system B maintains a client collaborative spreadsheet data representation.

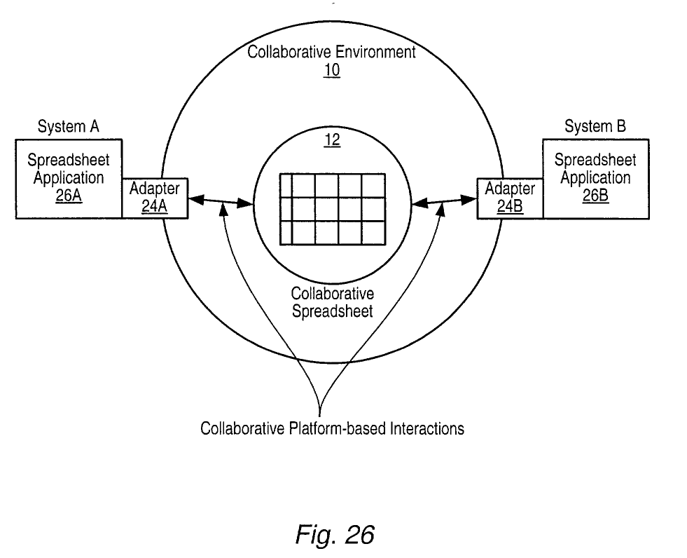

The server and client data representation interactions managed by the collaborative platforms allow each spreadsheet application to participate in a collaborative spreadsheet environment, as illustrated in FIG. 26. Thus, users of each spreadsheet application in the collaborative environment may effectively work on the same spreadsheet simultaneously and/or asynchronously. Each user may see each other user's modifications (for example, in different colors). Since system A hosts the server data representation spreadsheet, it performs modifications to the collaborative spreadsheet and sends state updates to the collaborative platform of system B to reflect spreadsheet modifications in system B's client data representation of the spreadsheet. In one embodiment, modifications to the spreadsheet requested by system B are not directly made to the client data representation spreadsheet at system B. Instead, the collaborative platform on system B forwards a modification command to system A so that the modification may be made to the server data representation spreadsheet. The collaborative platform on system A may then send a state update to the collaborative environment of system B to update the client data representation spreadsheet. Thus, changes to the collaborative spreadsheet are synchronized between the participants. As discussed below, the collaborative platform may provide security features so that permissions may be set so that a user may only modify specific information in the spreadsheet.

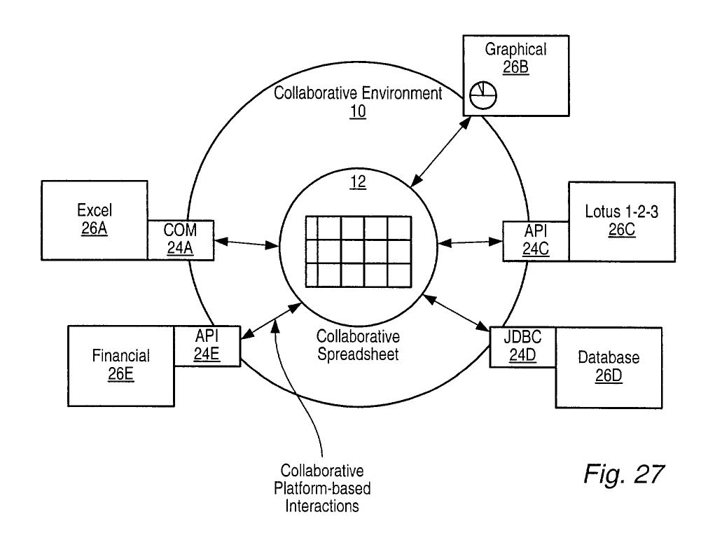

As illustrated in FIG. 27 different types of applications may participate in a collaborative environment by each coupling to a collaborative platform. For example, a one type of spreadsheet application 26C such as Lotus 1-2-3 may interact with the same collaborative spreadsheet resource 12 (e.g. through a client data representation) as an Excel spreadsheet application 26A. A database application 26D, financial application 26E or graphical application 26B may also collaborate on the spreadsheet resource for storing or viewing the collaborative spreadsheet. Each such application may have an adapter for its particular API in order to interface to a collaborative platform in the collaborative environment. Alternatively, an application may be modified or designed to interact directly with its collaborative platform, such as shown for graphical application 26B.

Note that the collaborative platform may be implemented in a device-platform independent language, such as Java, so that the same version of the collaborative platform may run one various different types of devices. Alternatively, native code implementations may be employed for different device types.

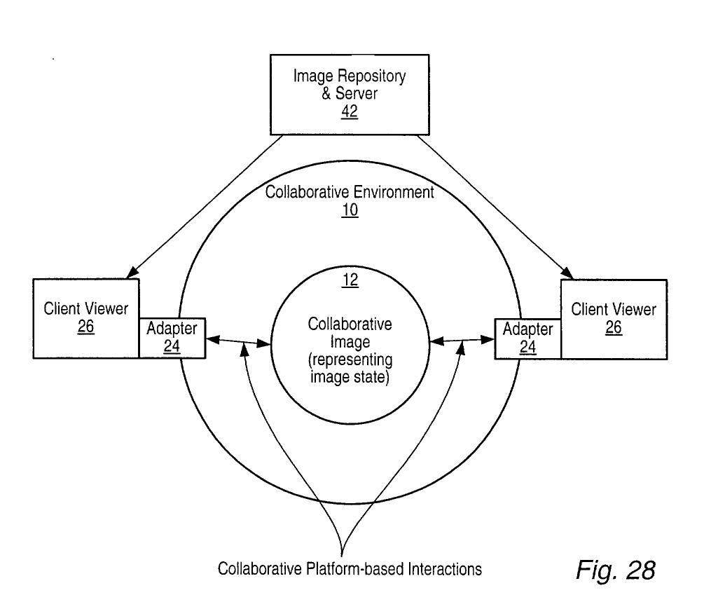

FIG. 28 illustrates another example in which client viewer applications 26 may interface through adapters 24 to a collaborative environment 10 in which a collaborative medical image 12, such as an x-ray, may be jointly viewed and/or modified in real-time by each client application. For example, doctors in different locations could use the collaborative environment to consult on patient images together remotely in realtime while pointing to and marking various features, sharing views, and talking with each other via voice over IP. One or more medical images may be the collaborative resources shared in the collaborative environment. As illustrated in FIG. 28, each client application may receive basic image components or static portions of the image from an image repository and server 42 in a traditional client-server fashion and collaborative actions or image data may be accessed in the collaborative environment. Thus, the collaborative environment may be used in conjunction with traditional client-server resources.

Due to the application and system independence provided by the collaborative platform, a wide range of applications and uses may be facilitated by use of the collaborative platform described herein. In addition to the spreadsheet and medical imaging examples given above other examples include collaborative notepads, white boards, games, etc. Such collaborative applications could be based on HTML web pages and integrated and delivered through client browsers, for example. Other examples include enterprise applications such as supply chain management in which a manufacturing enterprise could collaborate with its suppliers over inventory information. Distance learning is another example in which students may actively and interactively participate in a collaborative classroom environment.

The collaborative platform may provide one or more security features. Session security may be provided in which the collaborative platform provides a customizable low level protection for information being passed between collaborating participants. For example, traffic sent between the participants of a collaborative environment may be encrypted to prevent viewing or modification by entities not in the collaboration or entities within the collaboration not granted permission to a particular resource. Participant security may also be provided to authenticate participants such that entrance and access to the collaborative environment may be limited to allowed participants. The collaborative environment may support authentication of participants to track and ensure the identity of each participant at any time during the collaboration and to ensure that only participants which should be in the collaboration are allowed in. Resource security may also be provided by the collaborative platform by having different permissions for different participants and resources within the collaborative environment. Each participant and object in the collaborative environment may be assigned permissions which restrict the actions that a participant may perform on an object. The collaborative platform may also provide operating system security which respects any permissions that exist outside of the collaborative environment. For example, file permissions on the participant level in the operating system may be enforced within the collaborative platform for that participant.

The collaborative platform may also provide for logging and auditing all changes and communications received by or sent from the platform. Moreover, dynamic re-hosting of collaborative resources provided by mutability as described above may provide additional security by decentralizing the collaborative environment. For example, if one of the participants is subjected to a denial of service attack any collaborative resources hosted by that participant may by re-hosted elsewhere, thus preventing the denial of service attack from affecting the rest of the collaborative environment.

In one embodiment, the collaborative platform may be implemented in Java. Java's secure memory architecture minimizes the chance of security holes due to programming errors such as hard coded buffer sizes and invalid memory pointers. Java's strict scope rules allow enforcement of the collaborative platform's high-level security rules at a VM (virtual machine) level. Thus, when bringing together components from different vendors, security rules may be maintained for those individual components. The Java security manager may be used to allow the collaborative platform to control the hardware level interactions of the collaborative applications. These interactions can range from file access rules, to the opening of special purpose network sockets, to the allocation of memory. While Java is given as an example, other embodiments the distributed platform may be written in other languages that have a secure memory structure and provide the enforcement of scope rules, such as C-sharp.

The collaborative platform may employ standard libraries for encryption and authentication. This component may be modular to permit the user to change protocols based on different needs. Furthermore, the collaborative platform may use different encryption and authentication protocols at the same time. For example, a platform may use RSA public key cryptography for communication between company participants, but use Kerberos authentication for participants within one company's LAN. These different protocols may be completely transparent to the collaborative resources in the collaborative environment.

In one embodiment, every participant who enters the collaborative environment must authenticate with every participant whom they will communicate with. Each of these authenticated participants may have an extensible network permissions table that is enforced by the local copy of the collaborative platform. These permissions may range from the types of collaborative resources a remote participant is allowed to inject to the memory or bandwidth allocated to that participant's applications and communications.

A permissions system may be used throughout the collaborative environment and may be one of the stages in the pipeline for all communications between collaborative applications and their components. This permissions mechanism may be extensible and may be enforced on all participants in the environment. It may also regulated on the server side of each object so that malicious modification of a remote collaborative platform will not compromise any local security policies.

For example, a collaborative spreadsheet program, with a spreadsheet regarding expenses and revenues of each of the divisions of a business may be run on a participant. Rules may be implemented such that each divisional manager (other participants) can only change the expenses of their division. Furthermore, all other participants in the environment only have “read access” to all the information in the spreadsheet.

Because the collaborative environment works on the information level, auditing and logging of any type of information transaction may be provided. The collaborative platform may provide a developer a single entry point for communication to an object so even if auditing were not part of the original design of the application, it may be added and customized through the collaborative platform.

Collaborative resource objects may support a command-behavior paradigm. The command-behavior paradigm provides a pattern which separates syntax from semantics. Any request, programmatic, linguistic, or otherwise may have two separate parts—syntax and semantics. In natural language, syntax is the language of communication and semantics are the behaviors that are associate with that syntax. As an example, “sit down” is a syntactical element of the English language. The semantic mapping a person has with “sit down” is the actual act of sitting down. This syntax-semantic mapping, however, only exists if the person knows English. There is no guarantee that if a non-English speaker was told “dudukla” —the Indonesian equivalent for “sit down” —that he would do the right thing (or anything at all). Consequently, in language, syntax and semantics are not joined. The linkings between syntactical elements and behavioral responses can be dynamically learned, changed, and modified. Thus, the linkings may be dynamic.

In computer-implemented method invocations, these two pieces are joined: the syntax is the name of the method, the semantics are the resulting behaviors (the body of the method). Conventional techniques do not provide a mechanism to dynamically change, or remove the linking between a method and its body of code. Consequently, conventional linkings are static. The command-behavior paradigm provides a pattern which separates syntax from semantics. The syntactical element may be a command; the semantic element may be the behavior. The command-behavior paradigm allows for links to be formed between syntactical elements and semantic elements. Such a link may be referred to as a command-behavior link. A link may be executed, resulting in the process flow much like a traditional method. For example, where a method is invoked, a link is executed. When a command is executed on an object which supports the command-behavior paradigm, the command may be resolved to its linking (if one exists). If a linking exists, the associated behavior may be invoked, resulting in the behavior being performed. Further discussion and examples of the command-behavior paradigm are given below. In discussing the command-behavior paradigm, a notation may be employed in which a command-behavior linking is designated by writing the specific command first, followed by a hyphen, followed by the behavior. Examples are: JumpCmd-Jump, HitCmd-FallOver.

In one embodiment, the collaborative resource data representations may be implemented as objects that support the command-behavior paradigm. One or more behaviors may be defined for a command receiver object. Static linkings may be created between commands and behaviors. In one embodiment, commands not otherwise linked may be statically linked to a default behavior. Dynamic linkings may also be created or modified. The dynamic linking process may include the specification of a map object in order to transform the specified command type (or command instance) into the arguments required by the behavior. A LinkCmd-Link static linking may be executed to create dynamic links or to modify existing dynamic links. In one embodiment, protected and private behaviors may also be linked. Linking to behaviors may be performed by specifying a behavior ID—which is resolved upon execution of the link to the behavior. A command-behavior linking may be executed, e.g. by invoking a public method, to determine the behavior mapped to the received command. Links may be created for a particular command type or command instance.

A collaborative data resource may be an object which for which a client-server distribution model of the collaborative data resource is maintained across the network. A collaborative data resource may support the command-behavior paradigm. In some embodiments, collaborative data resources may exist in a graph formation. The collaborative platform may provide a distributed-mode command-behavior paradigm where a command received by a client representation of a collaborative data resource is processed by the server representation. If a command is sendable and the local collaborative data resource representation is a client representation, the command is routed using the network engine across the network to the server representation where the appropriate linking is executed. Otherwise, the linking is executed locally. The collaborative platform may also allow a server representation to update the state of its client representations. A mechanism may be provided to propagate a state from a server representation to its client representations. In some embodiments, the collaborative platform may provide for a server representation to update the state of specific ones of its client representations. For example, a connection list may be maintained and used to indicate the client representations to receive state updates from a server representation. The contents of the connection list of the state that is sent may be changed. A state with an empty connection list will be propagated to all the client representations of the server representation. A state with entries in its connection list is sent to all the valid entries in the connection list. The collaborative platform may also provide for a server representation to update the complete state of specific ones of its client representations. This may be useful to synchronize client representations to their server representation.

Collaborative data resource objects may be networkable so that the network engine may serialize the collaborative data resource object to send the collaborative data resource object as a stream of bytes (e.g. to create client data representations at remote environments). For a server data representation, a client data representation may be added to a remote environment or an existing client data representation on a remote environment may be removed. A connection ID may be added or removed on a connection list to reflect client data representation additions or removals. The particular participant systems which are to receive a client data representation in their local environment may be chosen. Listener objects may be specified to receive notification when a remote collaborative data resource representation is added or removed.

Specific embodiments are shown herein by way of example in the drawings and description. This disclosure is susceptible to various modifications and alternative forms. It should be understood that the drawings and description are not intended to limit any invention to the particular form disclosed, but on the contrary, are intended to be illustrative so that the inventions covers various modifications, equivalents, and alternatives. Note, the headings are for organizational purposes only and are not meant to be used to limit or interpret the description. Furthermore, note that the word “may” is used throughout this application in an optional or permissive sense, not a mandatory sense. The terms “have” and “include” and derivations thereof are used in a non-exhaustive sense, e.g. to mean “including, but not limited to.” The terms “coupled” or “connected” mean “directly or indirectly coupled/connected.”

Numerous variations and modifications will become apparent to those skilled in the art once the above disclosure is fully appreciated. It is intended that the disclosure be interpreted to embrace all such variations and modifications.

What is claimed is:

1. A system, comprising:
a network; and
a plurality of participant devices coupled to the network for collaborating on a plurality of collaborative resources, wherein each of the participant devices comprises a local data representation of each collaborative resource;
wherein for each collaborative resource, the local data representation at one of the participant devices is a server representation of the collaborative resource and the local data representations at the other participant devices are client representations of the collaborative resource;
wherein for each collaborative resource, the participant device having the server representation is configured to coordinate state changes to the collaborative resource among the local data representations of the participant devices; and
wherein for each collaborative resource, the participant devices having the client representations are configured to receive state changes for the collaborative resource from the participant device having the server representation.

2. The system as recited in claim 1, wherein for each collaborative resource, for a state change initiated to the collaborative resource by the participant device having the server representation of the collaborative resource, the participant device having the server representation of the collaborative resource is configured to perform the state change to the server representation and relay the state change to each participant device having a client representation of the collaborative resource.

3. The system as recited in claim 1, wherein for each collaborative resource, for a state change initiated to the collaborative resource by one of the participant devices having a client representation of the collaborative resource, the participant device initiating the state change is configured send the state change to the participant device having the server representation of the collaborative resource.

4. The system as recited claim 3, wherein for each collaborative resource, for a state change initiated to the collaborative resource by one of the participant devices having a client representation of the collaborative resource, the participant device having the server representation of the collaborative resource is configured to:
receive the state change from the participant device initiating the state change;
perform the state change to the server representation; and
relay the state change to each participant device having a client representation of the collaborative resource, including the participant device that initiated the state change.

5. The system as recited in claim 4, wherein for each collaborative resource, for a state change initiated to the collaborative resource by one of the participant devices having a client representation of the collaborative resource, each participant device having a client representation of the collaborative resource is configured to perform the state change to its client representation in response to receiving the state change from the participant device having the server representation of the collaborative resource.

6. The system as recited in claim 1, wherein each participant device further comprises:
an application configured to access one or more of the collaborative resources; and
a collaborative platform interfaced to the application, wherein the collaborative platform is configured to provide access for the application to the collaborative resources according to its local data representations.

7. The system as recited in claim 6, wherein the application is configured to generate state changes for one of the collaborative resources, and wherein the collaborative platform is configured to receive the state changes for the collaborative resource from the application and initiate real-time synchronization of the state changes to other participant devices.

8. The system as recited in claim 7, wherein the collaborative platform's role in the real-time synchronization of each state change to other participant devices depends on whether its local data representation of the collaborative resource targeted by the state change is the server representation or one of the client representations.

9. The system as recited in claim 8, wherein if the local data representation is the server representation, the collaborative platform is responsible for synchronizing the state change to the other participant devices.

10. The system as recited in claim 8, wherein if the local data representation is the client representation, the collaborative platform is configured to relay the state change to the participant device having the server representation of the collaborative resource target by the state change.

11. The system as recited in claim 6, wherein the collaborative platform is configured to receive a state change for one of the collaborative resources from another participant device and perform the state change to its local data representation of that collaborative resource, wherein the collaborative platform is configured to generate an event to the application so that the state change to the collaborative resource will appear in the application.

12. The system as recited in claim 6, wherein the collaborative platform is configured to receive a state change for one of the collaborative resources from another participant device, wherein the collaborative platform is configured to perform the state change to its local data representation of that collaborative resource and relay the state change to other ones of the participant device if the local data representation is the server representation, and wherein the collaborative platform is configured to perform the state change to its local data representation of that collaborative resource without relaying the state change to other ones of the participant device if the local data representation is one of the client representations of the collaborative resource.

13. The system as recited in claim 1, wherein the server representations of the collaborative resources are distributed among a plurality of different ones of the participant devices.

14. A device, comprising:
a network interface configured to couple the device to a network for communicating with one or more other devices;
a server representation of a first collaborative resource, wherein the server representation is configured to receive notification of state changes to the collaborative resource and send state change instructions through the network interface to the other devices to coordinate the state changes to client representations of the first collaborative resource at the other devices; and
a client representation of a second collaborative resource, wherein the client representation is configured to receive state change instructions for the second collaborative resource through the network interface from one of the other devices having a server representation of the collaborative resource, wherein the client representation is configured to update its state in response to the state change instructions for the second collaborative resource.

15. The device as recited in claim 14, further comprising:
an application configured to accesses the server representation of the first collaborative resource, wherein the application is configured to generate state changes to the first collaborative resource;
wherein the server representation is configured to:
receive the state changes from the application;
update its state in response to each state change; and
send a state change instruction in response to each state change through the network interface to other devices having client representations of the first collaborative resource.

16. The device as recited in claim 14, further comprising:
an application configured to accesses the server representation of the first collaborative resource;
wherein the server representation is configured to:
receive state changes for the first collaborative resource through the network interface from other devices having client representations of the first collaborative resource;
update its state in response to each state change; and
generate events to the application so that the state changes to the first collaborative resource appear in the application.

17. The device as recited in claim 16, wherein the server representation is further configured to, in response to each state change for the first collaborative resource received from another device having a client representation of the first collaborative resource, relay the state change to other devices having client representations of the first collaborative resource.

18. The device as recited in claim 14, further comprising:
an application configured to accesses the client representation of the second collaborative resource, wherein the application is configured to generate state changes to the second collaborative resource;
wherein the client representation is configured to:
receive the state changes from the application; and
send a notification of each state change through the network interface to a device having a server representation of the second collaborative resource.

19. The device as recited in claim 14, further comprising:
an application configured to accesses the client representation of the second collaborative resource;
wherein the client representation is configured to:
receive state changes for the second collaborative resource through the network interface from a device having a server representation of the second collaborative resource;
update its state in response to each state change received from the device having the server representation of the second collaborative resource; and
generate events to the application so that the state changes to the second collaborative resource appear in the application.

20. A method, comprising:
distributing a local data representation of a first collaborative resource to each of a plurality of participant devices, wherein the local data representation at one of the participant devices is a server representation and the local data representations at the other participant devices are client representations;
the server representation receiving a state change for the first collaborative resource, updating its state and relaying the state change to the client representations; and
the client representations each updating their state in response to receiving the state change from the server representation.

21. The method as recited in claim 20, wherein the state change is initiated at the participant device having the server representation of the first collaborative resource.

22. The method as recited in claim 20, wherein the state change is initiated at one of the participant devices having one of the client representations of the first collaborative resource, the method comprising the client representation at the participant device initiating the state change sending the state change to the server representation of the first collaborative resource.

23. The method as recited in claim 20, further comprising:
an application on one of the participant devices generating an event effecting the first collaborative resource;
translating the event into the state change;
communicating the state change to the local data representation of the first collaborative resource at that participant device to initiate real-time synchronization of the state change to the local data representations on other participant devices.

24. The method as recited in claim 20, further comprising, in response to a local data representation on one of the participant devices updating its state, generating an event to an application on that participant device so that the state change to the first collaborative resource will appear in the application.

25. The method as recited in claim 20, further comprising:
distributing a local data representation of a second collaborative resource to each of the participant devices, wherein the local data representation of the second collaborative resource at one of the participant devices is a server representation and the local data representations of the second collaborative resource at the other participant devices are client representations;
the server representation of the second collaborative resource receiving a state change for the second collaborative resource, updating its state and relaying the state change to the client representations of the second collaborative resource; and
the client representations of the second collaborative resource each updating their state in response to receiving the state change from the server representation.

26. The method as recited in claim 25, wherein the server representation of the second collaborative resource is at a different participant device than the server representation of the first collaborative resource.

27. A method, comprising:
initiating a state change within a local environment to a first collaborative resource;
if a local data representation of the first collaborative resource in the local environment is a server representation:
updating the server representation's state; and
relaying the state change to other participant environments having client representations of the first collaborative resource; and
if the local data representation of the first collaborative resource in the local environment is a client representation:
sending the state change to a participant environment having the server representation of the first collaborative resource.

28. The method as recited in claim 27, wherein the state change is initiated from an application event within the local environment, the method further comprising translating the application event into the state change.

29. The method as recited in claim 27, further comprising:
receiving a state change to the first collaborative resource from a remote environment;
updating the local data representation's state; and
if the local data representation is the server representation of the first collaborative resource, relaying the state change to other participant environments having client representations of the first collaborative resource.

30. The method as recited in claim 29, further comprising generating an event to a local application so that the state change received from the remote environment will appear in the local application.

31. A computer accessible medium comprising program instruction configured to implement:
initiating a state change within a local environment to a first collaborative resource;
if a local data representation of the first collaborative resource in the local environment is a server representation:
updating the server representation's state; and
relaying the state change to other participant environments having client representations of the first collaborative resource; and
if the local data representation of the first collaborative resource in the local environment is a client representation:
sending the state change to a participant environment having the server representation of the first collaborative resource.

32. The computer accessible medium as recited in claim 31, wherein the state change is initiated from an application event within the local environment, wherein the program instructions are further configured to implement translating the application event into the state change.

33. The computer accessible medium as recited in claim 31, wherein the program instructions are further configured to implement:
receiving a state change to the first collaborative resource from a remote environment;
updating the local data representation's state; and
if the local data representation is the server representation of the first collaborative resource, relaying the state change to other participant environments having client representations of the first collaborative resource.

34. The computer accessible medium as recited in claim 31, wherein the program instructions are further configured to implement generating an event to a local application so that the state change received from the remote environment will appear in the local application.
